(19) United States
(12) Patent Application Publication
(10) Pub. No.: US 2026/0277538 A1
(43) Pub. Date: Sep. 17, 2026

(54) REPRODUCTION DEVICE, REPRODUCTION METHOD, AND NON-TRANSITORY COMPUTER READABLE RECORDING MEDIUM STORING REPRODUCTION PROGRAM

(71) Applicant: PANASONIC INTELLECTUAL PROPERTY MANAGEMENT CO., LTD., Osaka (JP)

(72) Inventors: Takeshi SAKAI, Hyogo (JP); Nobuhiko WASHIO, Osaka (JP)

(21) Appl. No.: 19/671,631

(22) Filed: May 8, 2026

Related U.S. Application Data
(63) Continuation of application No. PCT/JP2024/028311, filed on Aug. 7, 2024.

(30) Foreign Application Priority Data
Nov. 10, 2023 (JP) 2023-192120

(51) Int. Cl. G06F 3/16; G10L 25/78

(52) U.S. Cl. CPC G06F 3/165; G10L 25/78

(57) ABSTRACT

A reproduction device acquires sensing information from a sensor, detects surrounding information indicating a surrounding state of a speaker based on the sensing information, selects one of a first sound signal including a conversation frequency range and a second sound signal not including the conversation frequency range based on the surrounding information, and reproduces one of the first sound signal and the second sound signal selected, and outputs the first sound signal or the second sound signal to the speaker. The surrounding information includes first information indicating the number of one or more persons present around the speaker.

### FIELD OF INVENTION

The present disclosure relates to a technology of reproducing sound.

### BACKGROUND ART

For example, Patent Literature 1 discloses a system for preventing eavesdropping on private conversations in a public space. In this system, a work-related or leisure group and an individual are detected. Then, in a region where there is a work-related or leisure group, volume of music is reduced, and a low frequency feature of the music is reduced. This means that people in the group do not need to speak louder than the sound of the music and can clearly hear each other's voices, and low frequency sounds do not mask their conversation. Further, in a region where there is an individual, volume of music is increased, and a low-frequency sound (sound of running water) is added so that the individual cannot clearly hear a conversation of a work-related or leisure group.

However, in the above-described conventional technology, providing an environment suitable for actions of one or more persons is not considered, and further improvement is needed.

Patent Literature 1: JP 2011-528445 A

### SUMMARY OF THE INVENTION

The present disclosure has been made to solve the above problem, and an object thereof is to provide a technology capable of providing an environment suitable for an action of one or more persons.

A reproduction device according to the present disclosure includes an acquisition unit that acquires sensing information from a sensor, a detection unit that detects surrounding information indicating a surrounding state of a speaker based on the sensing information, a sound selection unit that selects one of a first sound signal including a conversation frequency range and a second sound signal not including the conversation frequency range based on the surrounding information, and a sound reproduction unit that reproduces one of the first sound signal and the second sound signal selected, and outputs the first sound signal or the second sound signal to the speaker, in which the surrounding information includes first information indicating a number of one or more persons present around the speaker.

According to the present disclosure, it is possible to provide an environment suitable for an action of one or more persons.

### BRIEF DESCRIPTION OF THE DRAWINGS

FIG. 1 is a view illustrating an external configuration of a reproduction fixture according to a first embodiment.

FIG. 2 is a block diagram illustrating a configuration of a reproduction device according to the first embodiment.

FIG. 3 is a diagram illustrating an example of a Russell's circumplex model.

FIG. 4 is a diagram illustrating a relationship between a first sound signal and a second sound signal according to the first embodiment.

FIG. 5 is a diagram illustrating a relationship among the number of persons around a speaker, a state of the persons around the speaker, a sound content to be reproduced, and a video content to be reproduced according to the first embodiment.

FIG. 6 is a flowchart for describing reproduction processing by the reproduction device according to the first embodiment of the present disclosure.

FIG. 7 is a view illustrating an external configuration of the reproduction fixture according to a modification example of the first embodiment.

FIG. 8 is a view illustrating an external configuration of a reproduction fixture according to a second embodiment.

FIG. 9 is a block diagram illustrating a configuration of a reproduction device according to the second embodiment.

FIG. 10 is a block diagram illustrating a configuration of a reproduction device according to a third embodiment.

FIG. 11 is a view illustrating an external configuration of a reproduction fixture according to a fourth embodiment.

FIG. 12 is a block diagram illustrating a configuration of a reproduction device according to the fourth embodiment.

FIG. 13 is a first flowchart for describing reproduction processing by the reproduction device according to the fourth embodiment of the present disclosure.

FIG. 14 is a second flowchart for describing the reproduction processing by the reproduction device according to the fourth embodiment of the present disclosure.

FIG. 15 is a flowchart for describing conversation determination processing by a reproduction control unit according to the fourth embodiment of the present disclosure.

FIG. 16 is a diagram illustrating an example of a time characteristic of sound information in a first period.

FIG. 17 is a diagram illustrating an example of a frequency characteristic of sound information in the first period.

FIG. 18 is a block diagram illustrating a configuration of a reproduction device according to a fifth embodiment.

FIG. 19 is a first flowchart for describing reproduction processing by the reproduction device according to the fifth embodiment of the present disclosure.

FIG. 20 is a second flowchart for describing reproduction processing by the reproduction device according to the fifth embodiment of the present disclosure.

FIG. 21 is a third flowchart for describing reproduction processing by the reproduction device according to the fifth embodiment of the present disclosure.

FIG. 22 is a view illustrating an external configuration of the reproduction fixture according to Modification Example 1 of the first to fifth embodiments.

FIG. 23 is a view illustrating an external configuration of the reproduction fixture according to Modification Example 2 of the first to fifth embodiments.

FIG. 24 is a view illustrating an external configuration of the reproduction fixture according to Modification Example 3 of the first to fifth embodiments.

FIG. 25 is a view illustrating an external configuration of the reproduction fixture according to Modification Example 4 of the first to fifth embodiments.

FIG. 26 is a view illustrating an external configuration of the reproduction fixture according to Modification Example 5 of the first to fifth embodiments.

FIG. 27 is a view illustrating an external configuration of the reproduction fixture according to Modification Example 6 of the first to fifth embodiments.

### DETAILED DESCRIPTION

### Knowledge underlying present disclosure

In Patent Literature 1 described above, when there is a work-related or leisure group in the first area, the volume of music in the first area is reduced. Thus, in the first area, people no longer need to speak louder than the sound of the music, and conversation becomes easier.

Further, in Patent Literature 1 described above, when there is a customer in the work-related or leisure group in the first area and there is an individual customer in a second area adjacent to the first area, volume of music in the second area is increased and a sound of running water is added to the second area. Thus, in the second area, a conversation of people in the first area is masked, and eavesdropping on a private conversation in a public place is prevented.

However, Patent Literature 1 does not consider encouraging a plurality of persons in the first area to have a conversation or relaxing an individual in the second area, and does not consider providing an environment suitable for an action of one or more persons.

In order to solve the above problem, the following technology is disclosed.

(1) A reproduction device according to one aspect of the present disclosure includes an acquisition unit that acquires sensing information from a sensor, a detection unit that detects surrounding information indicating a surrounding state of a speaker based on the sensing information, a sound selection unit that selects one of a first sound signal including a conversation frequency range and a second sound signal not including the conversation frequency range based on the surrounding information, and a sound reproduction unit that reproduces one of the first sound signal and the second sound signal selected, and outputs the first sound signal or the second sound signal to the speaker, in which the surrounding information includes first information indicating a number of one or more persons present around the speaker.

It is said that a sound including a conversation frequency range has an effect of encouraging people to have a conversation. Thus, when two or more persons are present around the speaker, it is possible to encourage the two or more persons to have a conversation by reproducing the first sound signal including the conversation frequency range. Further, it is said that a sound that does not include a conversation frequency range has an effect of relaxing a person. Thus, when one person is present around the speaker, it is possible to relax the one person by reproducing the second sound signal not including the conversation frequency range. Therefore, it is possible to provide an environment suitable for the action of one or more persons.

(2) In the reproduction device according to (1), the surrounding information may further include second information indicating whether or not two or more persons present around the speaker are having a conversation.

When two or more persons are present having a conversation around the speaker, it is possible to encourage the two or more persons to have a conversation by reproducing the first sound signal including the conversation frequency range. Further, when one person is present around the speaker or when two or more persons are present who are not having a conversation around the speaker, it is possible to relax the one person or two or more persons by reproducing the second sound signal not including the conversation frequency range. Therefore, it is possible to provide an environment suitable for the action of one or more persons.

(3) The reproduction device according to (2) may further include a video selection unit that selects one of a first video signal to be reproduced together with the first sound signal and a second video signal to be reproduced together with the second sound signal based on the surrounding information, and a video reproduction unit that reproduces either the first video signal or the second video signal selected and outputs the first video signal or the second video signal to one or more displays.

With this configuration, not only one of the first sound signal and the second sound signal but also one of the first video signal and the second video signal is reproduced. Therefore, not only sound but also video can encourage two or more persons to have a conversation, and one person or two or more persons can be relaxed, so that an environment more suitable for the action of one or more persons can be provided.

(4) In the reproduction device according to (3), the sound selection unit may select the first sound signal when two or more persons are present around the speaker and the two or more persons are having a conversation, and the video selection unit may select the first video signal when two or more persons are present around the speaker and the two or more persons are having a conversation.

With this configuration, when two or more persons are present around the speaker and two or more persons are having a conversation, the first sound signal and the first video signal are reproduced, so that it is possible to encourage the two or more persons to have a conversation.

(5) In the reproduction device according to (3), the sound selection unit may select the second sound signal when one person is present around the speaker or when two or more persons are present around the speaker and the two or more persons are not having a conversation, and the video selection unit may select the second video signal when one person is present around the speaker or when two or more persons are present around the speaker and the two or more persons are not having a conversation.

With this configuration, when one person is present around the speaker, or when two or more persons are present around the speaker and two or more persons are not having a conversation, the second sound signal and the second video signal are reproduced, so that one person or two or more persons can be relaxed.

(6) In the reproduction device according to (2), the surrounding information further may include third information indicating whether or not one or more persons present around the speaker are working, the sound selection unit may select the second sound signal when one person is present around the speaker and the one person is not working or when two or more persons are present around the speaker and the two or more persons are not working, the sound selection unit may select a third sound signal when one person is present around the speaker and the one person is working, or when two or more persons are present around the speaker and the two or more persons are working, the sound reproduction unit may reproduce any one of the first sound signal, the second sound signal, and the third sound signal selected, and output the sound signal to the speaker, the first sound signal may be a nonstationary sound including the conversation frequency range, the second sound signal may be a nonstationary sound not including the conversation frequency range, and the third sound signal may be a stationary sound including the conversation frequency range.

It is said that a nonstationary sound including a conversation frequency range has an effect of encouraging people to have a conversation. Thus, when two or more persons are present around the speaker and the two or more persons are having a conversation, the first sound signal that is a nonstationary sound including the conversation frequency range is reproduced, so that it is possible to further encourage the conversation of the two or more persons who are having a conversation. Further, it is said that a nonstationary sound not including a conversation frequency range has an effect of relaxing a person. Thus, when one person is present around the speaker and the one person is not working, or when two or more persons are present around the speaker and the two or more persons are not working, the second sound signal that is a nonstationary sound not including the conversation frequency range is reproduced, so that the one person or two or more persons who are not working can be relaxed. Further, a stationary sound including a conversation frequency range is said to have an effect of increasing concentration of a person. Thus, when one person is present around the speaker and the one person is working, or when two or more persons are present around the speaker and the two or more persons are working, the third sound signal that is a stationary sound including the conversation frequency range is reproduced, and thus it is possible to enhance the concentration of the one person or two or more persons who are working.

(7) The reproduction device according to (6) may further include a video selection unit that selects one of a first video signal to be reproduced together with the first sound signal, a second video signal to be reproduced together with the second sound signal, and a third video signal to be reproduced together with the third sound signal based on the surrounding information, and a video reproduction unit that reproduces one of the first video signal, the second video signal, and the third video signal that is selected, and outputs the one of the first video signal, the second video signal, and the third video signal to one or more displays.

With this configuration, not only one of the first sound signal, the second sound signal, and the third sound signal but also one of the first video signal, the second video signal, and the third video signal is reproduced. Therefore, not only sound but also video can encourage two or more persons to have a conversation, one person or two or more persons can be relaxed, concentration of one person or two or more persons who are working can be enhanced, and an environment more suitable for actions of one or more persons can be provided.

(8) In the reproduction device according to (3), the sound reproduction unit may change a volume of either the first sound signal or the second sound signal selected, and the video selection unit may change luminance of either the first video signal or the second video signal that is selected.

With this configuration, for example, the volume of the second sound signal is reduced below the volume of the first sound signal, and the luminance of the second video signal is reduced below the luminance of the first video signal, so that the relaxation effect can be further enhanced.

(9) In the reproduction device according to (3), the sensing information may include sound information in a first period acquired from a microphone, the detection unit may detect silent sections in the first period of the one or more persons and a sound pressure level of a conversation frequency range in the first period of the one or more persons based on the sound information, and determine that the two or more persons are having a conversation when a total of the silent sections is equal to or less than a second period and the sound pressure level of the conversation frequency range is equal to or greater than a threshold, the sound selection unit may select the first sound signal when two or more persons are present around the speaker and the two or more persons are having a conversation, and the video selection unit may select the first video signal when two or more persons are present around the speaker and the two or more persons are having a conversation.

With this configuration, it is possible to determine whether or not two or more persons are having a conversation based on the sound information acquired from the microphone.

(10) In the reproduction device according to (3), the acquisition unit may further acquire time information indicating a current time, the sound selection unit may select the second sound signal corresponding to the current time based on the surrounding information and the time information, and the video selection unit may select the second video signal corresponding to the current time based on the surrounding information and the time information.

With this configuration, since the second sound signal and the second video signal corresponding to the current time are selected, it is possible to provide an environment in which the flow of time is felt like being in a natural environment.

(11) In the reproduction device according to (3), the acquisition unit may further acquire weather information regarding a current weather, the sound selection unit may select the second sound signal corresponding to the current weather based on the surrounding information and the weather information, and the video selection unit may select the second video signal corresponding to the current weather based on the surrounding information and the weather information.

With this configuration, since the second sound signal and the second video signal corresponding to the current weather are selected, it is possible to provide an environment in which a change in weather is felt like being in a natural environment.

(12) In the reproduction device according to (3), the surrounding information may further include fourth information indicating whether or not a person is present in front of each of the one or more displays, the reproduction device may further include a determination unit that determines whether or not the person is present in front of each of the one or more displays based on the fourth information, and the video reproduction unit may reproduce one of the first video signal and the second video signal selected, and output the one of the first video signal and the second video signal to the display in front of which it is determined that the person is present.

With this configuration, one of the first video signal and the second video signal is output to the display in front of which it is determined that the person is present, and the first video signal and the second video signal are not output to the display in front of which it is determined that the person is not present, whereby the first video signal or the second video signal is not displayed on all the displays, and the power consumption necessary for the display can be suppressed.

(13) In the reproduction device according to (3), one or more tables may be disposed in front of the one or more displays, respectively, and the first information may indicate, for each of the one or more tables, a number of one or more persons who use the table, and the second information may indicate, for each of the one or more tables, whether or not two or more persons using the table are having a conversation.

With this configuration, since the table is disposed in front of the display, a person who uses the table can be associated with the display, and the person who uses the table can be identified as the person who uses the display.

(14) In the reproduction device according to any one of (1) to (13), the sensor may include at least one of a camera, a microphone, or a human detection sensor.

With this configuration, by acquiring the sensing information from at least one of the camera, the microphone, and the human detection sensor, the surrounding information indicating the state around the speaker can be detected.

(15) The reproduction device according to any one of (1) to (13) may further include a lighting control unit that determines at least one of a color temperature or illuminance of a lighting device disposed near the speaker based on the surrounding information, and outputs a control signal for controlling the lighting device to the lighting device based on the determined at least one of the color temperature or the illuminance.

With this configuration, the lighting device is controlled based on at least one of the color temperature or the illuminance determined based on the surrounding information. Therefore, not only sound but also light can encourage two or more persons to have a conversation, and one person or two or more persons can be relaxed, so that an environment more suitable for the action of one or more persons can be provided.

Further, the present disclosure can be implemented not only as a reproduction device having the characteristic configuration as described above but also as a reproduction method or the like of executing characteristic processing corresponding to the characteristic configuration included in the reproduction device. Further, the present disclosure can also be implemented as a computer program that causes a computer to execute characteristic processing included in the reproduction method described above. Therefore, the other aspects below can achieve the same effects as the above-described reproduction device.

(16) A reproduction method according to another aspect of the present disclosure is a reproduction method executed by a computer, the reproduction method including acquiring sensing information from a sensor, detecting surrounding information indicating a surrounding state of a speaker based on the sensing information, selecting one of a first sound signal including a conversation frequency range and a second sound signal not including the conversation frequency range based on the surrounding information, and reproducing one of the first sound signal and the second sound signal selected, and outputting the first sound signal or the second sound signal to the speaker, in which the surrounding information includes first information indicating a number of one or more persons present around the speaker.

(17) A reproduction program according to another aspect of the present disclosure causes a computer to function as an acquisition unit that acquires sensing information from a sensor, a detection unit that detects surrounding information indicating a surrounding state of a speaker based on the sensing information, a sound selection unit that selects one of a first sound signal including a conversation frequency range and a second sound signal not including the conversation frequency range based on the surrounding information, and a sound reproduction unit that reproduces one of the first sound signal and the second sound signal selected, and outputs the first sound signal or the second sound signal to the speaker, in which the surrounding information includes first information indicating a number of one or more persons present around the speaker.

(18) A non-transitory computer-readable recording medium according to another aspect of the present disclosure records a reproduction program, the reproduction program causing a computer to function as an acquisition unit that acquires sensing information from a sensor, a detection unit that detects surrounding information indicating a surrounding state of a speaker based on the sensing information, a sound selection unit that selects one of a first sound signal including a conversation frequency range and a second sound signal not including the conversation frequency range based on the surrounding information, and a sound reproduction unit that reproduces one of the first sound signal and the second sound signal selected, and outputs the first sound signal or the second sound signal to the speaker, in which the surrounding information includes first information indicating a number of one or more persons present around the speaker.

Hereinafter, embodiments of the present disclosure will be described with reference to the accompanying drawings. Note that the embodiment described below illustrates one specific example of the present disclosure. Numerical values, shapes, components, steps, order of steps, and the like of the embodiments below are merely examples, and are not intended to limit the present disclosure. Further, a component not described in an independent claim representing a highest concept among components in the embodiments below is described as an optional component. In all the embodiments, respective contents can be combined.

### First embodiment

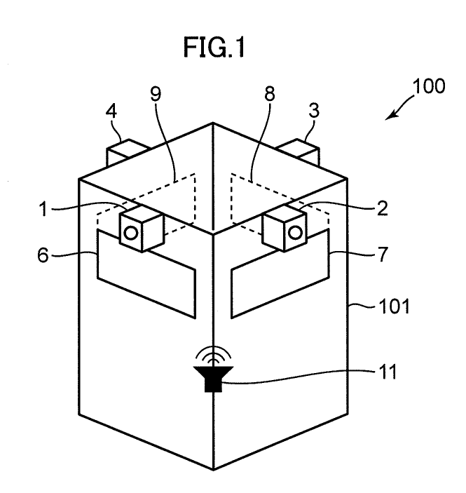

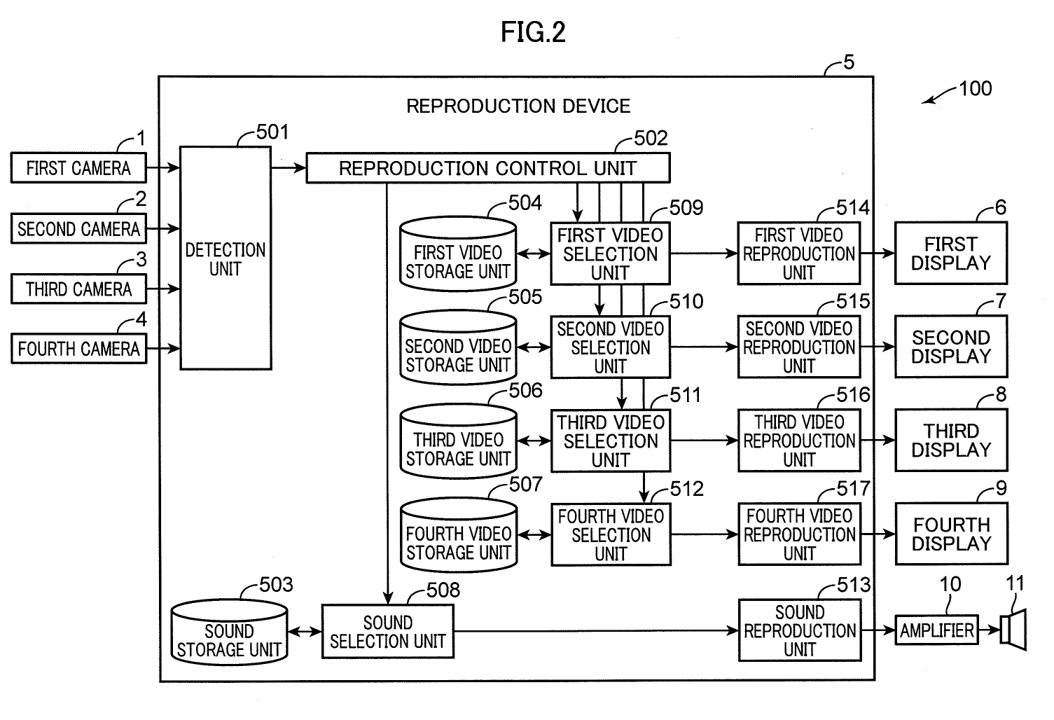

FIG. 1 is a view illustrating an external configuration of a reproduction fixture 100 according to the first embodiment, and FIG. 2 is a block diagram illustrating a configuration of a reproduction device 5 according to the first embodiment.

The reproduction fixture 100 is disposed, for example, in a place where a plurality of persons can gather, such as an office room of an office, an entrance of a building, a rest room of a building, a cafe, a restaurant, a hospital, and a nursing care facility.

The reproduction fixture 100 includes a first camera 1, a second camera 2, a third camera 3, a fourth camera 4, a reproduction device 5, a first display 6, a second display 7, a third display 8, a fourth display 9, an amplifier 10, a speaker 11, and a housing 101.

The housing 101 has a quadrangular prism shape. An opening is formed on an upper surface of the housing 101. A space is formed inside the housing 101. For example, a house plant or the like may be provided inside the housing 101.

The first display 6, the second display 7, the third display 8, and the fourth display 9 are provided on the four side surfaces of the housing 101, respectively. The first display 6, the second display 7, the third display 8, and the fourth display 9 are, for example, liquid crystal displays.

The first camera 1, the second camera 2, the third camera 3, and the fourth camera 4 are provided on the four side surfaces of the housing 101, respectively. The first camera 1 is provided above the first display 6 and images a space in front of the first display 6. The second camera 2 is provided above the second display 7 and images a space in front of the second display 7. The third camera 3 is provided above the third display 8 and images a space in front of the third display 8. The fourth camera 4 is provided above the fourth display 9 and images a space in front of the fourth display 9. The first camera 1, the second camera 2, the third camera 3, and the fourth camera 4 are examples of sensors.

The first camera 1, the second camera 2, the third camera 3, and the fourth camera 4 are connected to the reproduction device 5 itself or a hub (not illustrated) such as a communication device or a server in a wired or wireless manner so that a captured image can be input to the reproduction device 5. The first camera 1, the second camera 2, the third camera 3, and the fourth camera 4 may be communicably connected to the reproduction device 5 via a network. The first camera 1, the second camera 2, the third camera 3, and the fourth camera 4 output captured images to the reproduction device 5. The image is an example of sensing information.

Note that images captured by the first camera 1, the second camera 2, the third camera 3, and the fourth camera 4 may be output in real time, or an image may be output from an external storage device such as a memory or a cloud server after the image is once recorded in the external storage device.

The reproduction device 5 is provided inside the housing 101. The reproduction device 5 includes a detection unit 501, a reproduction control unit 502, a sound storage unit 503, a first video storage unit 504, a second video storage unit 505, a third video storage unit 506, a fourth video storage unit 507, a sound selection unit 508, a first video selection unit 509, a second video selection unit 510, a third video selection unit 511, a fourth video selection unit 512, a sound reproduction unit 513, a first video reproduction unit 514, a second video reproduction unit 515, a third video reproduction unit 516, and a fourth video reproduction unit 517.

The reproduction device 5 includes at least a computer system including, for example, a control program, a processing circuit such as a processor or a logic circuit that executes the control program, and a recording device such as an internal memory or an accessible external memory that stores the control program. Note that the reproduction device 5 may be implemented by, for example, hardware implementation by a processing circuit, execution of a software program held in a memory by a processing circuit or distributed from an external server, or a combination of these hardware implementation and software implementation. In addition, the reproduction device 5 may be a server.

The detection unit 501 acquires images (sensing information) from each of the first camera 1, the second camera 2, the third camera 3, and the fourth camera 4. The detection unit 501 detects surrounding information indicating a state around the speaker 11 based on the image (sensing information). The surrounding information includes first information indicating the number of one or more persons present around the speaker 11, second information indicating whether or not two or more persons present around the speaker 11 are having a conversation, and third information indicating whether or not one or more persons present around the speaker 11 are working.

The detection unit 501 detects the number of persons around the speaker 11 based on a plurality of images captured by each of the first camera 1, the second camera 2, the third camera 3, and the fourth camera 4.

The detection unit 501 inputs a plurality of images captured by each of the first camera 1, the second camera 2, the third camera 3, and the fourth camera 4 to a person detection model, and acquires the number of persons present around the speaker 11 from the person detection model. The person detection model is created by machine learning using an image of a person as training data. When a plurality of images obtained by imaging the surroundings of the speaker 11 is input to the person detection model, the person detection model outputs the number of persons present around the speaker 11. Note that the person detection model may be created by machine learning using an image obtained by imaging the surroundings of the speaker 11 and the number of persons present around the speaker 11 as training data. The detection unit 501 may sum the number of persons detected from each of the plurality of images.

Further, the detection unit 501 determines whether or not two or more persons present around the speaker 11 are having a conversation based on a plurality of images captured by each of the first camera 1, the second camera 2, the third camera 3, and the fourth camera 4.

The detection unit 501 inputs a plurality of images captured by each of the first camera 1, the second camera 2, the third camera 3, and the fourth camera 4 into a conversation determination model, and acquires a determination result indicating whether or not two or more persons present around the speaker 11 are having a conversation from the conversation determination model. The conversation determination model is created by machine learning using an image in which a person is having a conversation and a determination result indicating that the person is having a conversation as training data. When a plurality of images obtained by imaging the surroundings of the speaker 11 is input to the conversation determination model, the conversation determination model outputs a determination result indicating whether or not two or more persons present around the speaker 11 are having a conversation. Note that the conversation determination model may be created by machine learning using an image in which a person is having a conversation, an image in which the person is performing an action other than a conversation, and a determination result indicating whether or not the person is having a conversation as training data. The detection unit 501 may determine whether or not a person is having a conversation with respect to each of the plurality of images, and may determine that two or more persons present around the speaker 11 are having a conversation when two or more determination results indicating that the person is having a conversation are obtained.

Further, the detection unit 501 determines whether or not one or more persons present around the speaker 11 are working based on a plurality of images captured by each of the first camera 1, the second camera 2, the third camera 3, and the fourth camera 4.

The detection unit 501 inputs a plurality of images captured by each of the first camera 1, the second camera 2, the third camera 3, and the fourth camera 4 to a work determination model, and acquires a determination result indicating whether or not one or more persons present around the speaker 11 are working from the work determination model. The work determination model is created by machine learning using an image in which a person is working and a determination result indicating that the person is working as training data. When a plurality of images obtained by imaging the surroundings of the speaker 11 is input to the work determination model, the work determination model outputs a determination result indicating whether or not one or more persons present around the speaker 11 are working. Note that the work determination model may be created by machine learning using an image in which a person is working, an image in which the person is performing an action other than work, and a determination result indicating whether or not the person is working as training data. The detection unit 501 may determine whether or not a person is working on each of the plurality of images, and determine that one or more persons present around the speaker 11 are working when one or more determination results indicating that the person is working are obtained.

The sound storage unit 503 stores in advance a first sound signal and a third sound signal including a conversation frequency range and a second sound signal not including the conversation frequency range. The conversation frequency range is a frequency band used by a person in conversation, and is, for example, 125 Hz to 2000 Hz.

The first sound signal is a nonstationary sound including the conversation frequency range. The first sound signal is a sound for encouraging conversation, and is, for example, a crowd sound or a wave sound.

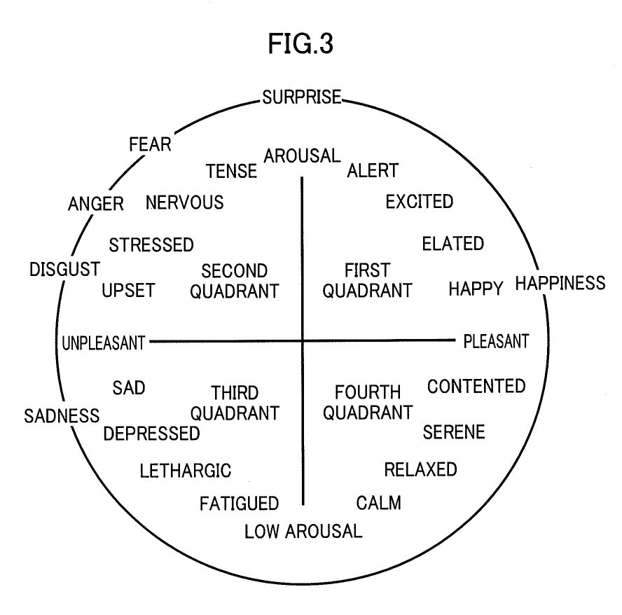

FIG. 3 is a diagram illustrating an example of Russell's circumplex model.

The first sound signal may be, for example, a sound evaluated to be in the first quadrant of Russell's circumplex model by causing a plurality of persons to hear a plurality of sounds of various types. Conventionally, Russell's circumplex model illustrated in FIG. 3 is known as one of emotion models. The Russell's circumplex model is a model indicating that all emotions are arranged on a plane expressed in two dimensions of an axis indicating comfort and discomfort and an axis indicating awakening and non-awakening.

The second sound signal is a nonstationary sound not including the conversation frequency range. The second sound signal is a sound having a relaxation effect, and is, for example, a lakeside sound, a bird chirping sound, a river flowing sound, or a combination of these sounds. The second sound signal is a sound including a frequency band higher than the conversation frequency range, and is a sound including a frequency band higher than 2000 Hz. The second sound signal may be, for example, a sound evaluated to be in the fourth quadrant of the Russell's circumplex model by causing a plurality of persons to hear a plurality of sounds of various types.

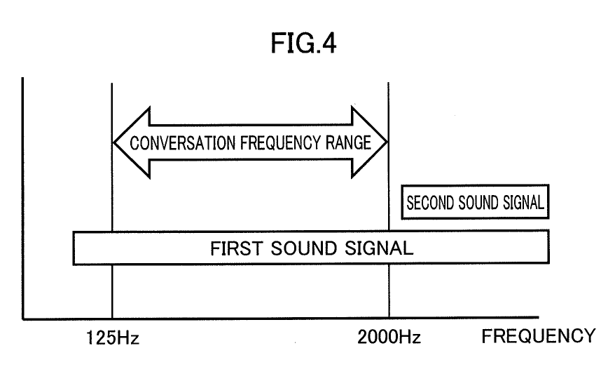

FIG. 4 is a diagram illustrating a relationship between the first sound signal and the second sound signal in the first embodiment.

As illustrated in FIG. 4, the first sound signal includes the conversation frequency range of 125 Hz to 2000 Hz. Further, the second sound signal does not include the conversation frequency range but includes a frequency band higher than 2000 Hz.

The third sound signal is a stationary sound including the conversation frequency range. The third sound signal is a sound for enhancing concentration, and is, for example, a sound of a waterfall. The third sound signal may be, for example, a sound evaluated to be in the fourth quadrant of the Russell's circumplex model by causing a plurality of persons to hear a plurality of sounds of various types.

The first video storage unit 504 stores in advance a first video signal to be reproduced together with the first sound signal, a second video signal to be reproduced together with the second sound signal, and a third video signal to be reproduced together with the third sound signal.

The first video signal is a video for encouraging conversation, and is, for example, a crowd video or a video obtained by imaging a scene where a person is active (for example, a conversation). The first video signal may be, for example, a video evaluated to be in the first quadrant of the Russell's circumplex model by causing a plurality of persons to watch a plurality of videos of various types.

The second video signal is a video having a relaxation effect, and is, for example, a video of a lake or a video of a river flowing. The second video signal is a video not including a person and obtained by imaging a natural landscape. The second video signal may be, for example, a video evaluated to be in the fourth quadrant of the Russell's circumplex model by causing a plurality of persons to watch a plurality of videos of various types.

The third video signal is a video for enhancing concentration, and is, for example, a video of a waterfall. The third video signal is a video not including a person and obtained by imaging a natural landscape. The third video signal may be, for example, a video evaluated to be in the fourth quadrant of the Russell's circumplex model by causing a plurality of persons to watch a plurality of videos of various types.

Note that the sound for encouraging conversation, the sound having a relaxation effect, the sound for enhancing concentration, the video for encouraging conversation, the video having a relaxation effect, and the video for enhancing concentration may be changed depending on the location where the reproduction fixture 100 is disposed or the attribute of the person who uses the reproduction fixture 100. Note that the attribute of the person is, for example, a job category, age, gender, race, or the like.

The second video storage unit 505 stores the first video signal, the second video signal, and the third video signal in advance.

The third video storage unit 506 stores the first video signal, the second video signal, and the third video signal in advance.

The fourth video storage unit 507 stores the first video signal, the second video signal, and the third video signal in advance.

Note that the first video storage unit 504, the second video storage unit 505, the third video storage unit 506, and the fourth video storage unit 507 store the same data.

The reproduction control unit 502 instructs the sound selection unit 508 to select one of the first sound signal including the conversation frequency range, the second sound signal not including the conversation frequency range, and the third sound signal based on the surrounding information. The reproduction control unit 502 determines whether or not two or more persons are present around the speaker 11. Further, the reproduction control unit 502 determines whether or not two or more persons are having a conversation. Further, the reproduction control unit 502 determines whether or not one or more persons present around the speaker 11 are working.

When two or more persons are present around the speaker 11 and the two or more persons are having a conversation, the reproduction control unit 502 instructs the sound selection unit 508 to select the first sound signal.

Further, when one person is present around the speaker 11 and the one person is not working, the reproduction control unit 502 instructs the sound selection unit 508 to select the second sound signal. Further, when two or more persons are present around the speaker 11 and the two or more persons are not working, the reproduction control unit 502 instructs the sound selection unit 508 to select the second sound signal.

Further, when one person is present around the speaker 11 and the one person is working, the reproduction control unit 502 instructs the sound selection unit 508 to select the third sound signal. Further, when two or more persons are present around the speaker 11 and the two or more persons are working, the reproduction control unit 502 instructs the sound selection unit 508 to select the third sound signal.

Further, when two or more persons are present around the speaker 11 and the two or more persons are having a conversation, the reproduction control unit 502 instructs the first video selection unit 509, the second video selection unit 510, the third video selection unit 511, and the fourth video selection unit 512 to select the first video signal.

Further, when one person is present around the speaker 11 and the one person is not working, the reproduction control unit 502 instructs the first video selection unit 509, the second video selection unit 510, the third video selection unit 511, and the fourth video selection unit 512 to select the second video signal. Further, when two or more persons are present around the speaker 11 and the two or more persons are not working, the reproduction control unit 502 instructs the first video selection unit 509, the second video selection unit 510, the third video selection unit 511, and the fourth video selection unit 512 to select the second video signal.

Further, when one person is present around the speaker 11 and the one person is working, the reproduction control unit 502 instructs the first video selection unit 509, the second video selection unit 510, the third video selection unit 511, and the fourth video selection unit 512 to select the third video signal. Further, when two or more persons are present around the speaker 11 and the two or more persons are working, the reproduction control unit 502 instructs the first video selection unit 509, the second video selection unit 510, the third video selection unit 511, and the fourth video selection unit 512 to select the third video signal.

The sound selection unit 508 selects one of the first sound signal, the second sound signal, and the third sound signal according to the instruction from the reproduction control unit 502.

The sound selection unit 508 selects one of the first sound signal including the conversation frequency range, the second sound signal not including the conversation frequency range, and the third sound signal based on the surrounding information. When two or more persons are present around the speaker 11 and the two or more persons are having a conversation, the sound selection unit 508 selects the first sound signal. When one person is present around the speaker 11 and the one person is not working, the sound selection unit 508 selects the second sound signal. Further, when two or more persons are present around the speaker 11 and two or more persons are not working, the sound selection unit 508 selects the second sound signal. When one person is present around the speaker 11 and the one person is working, the sound selection unit 508 selects the third sound signal. Further, when two or more persons are present around the speaker 11 and two or more persons are working, the sound selection unit 508 selects the third sound signal.

The sound selection unit 508 reads the selected one of first sound signal, second sound signal, and third sound signal from the sound storage unit 503. The sound selection unit 508 outputs the read one of first sound signal, second sound signal, and third sound signal to the sound reproduction unit 513.

Note that the sound selection unit 508 may select either the first sound signal including the conversation frequency range or the second sound signal not including the conversation frequency range based on the surrounding information. When one person is present around the speaker 11, the sound selection unit 508 may select the second sound signal. In addition, when two or more persons are present around the speaker 11 and the two or more persons are not having a conversation, the sound selection unit 508 may select the second sound signal.

The first video selection unit 509 selects one of the first video signal, the second video signal, and the third video signal according to the instruction from the reproduction control unit 502.

The first video selection unit 509 selects one of the first video signal to be reproduced together with the first sound signal, the second video signal to be reproduced together with the second sound signal, and the third video signal to be reproduced together with the third sound signal based on the surrounding information. When two or more persons are present around the speaker 11 and the two or more persons are having a conversation, the first video selection unit 509 selects the first video signal. When one person is present around the speaker 11 and the one person is not working, the first video selection unit 509 selects the second video signal. Further, when two or more persons are present around the speaker 11 and the two or more persons are not working, the first video selection unit 509 selects the second video signal. When one person is present around the speaker 11 and the one person is working, the first video selection unit 509 selects the third video signal. Further, when two or more persons are present around the speaker 11 and two or more persons are working, the first video selection unit 509 selects the third video signal.

The first video selection unit 509 reads the selected one of first video signal, second video signal, and third video signal from the first video storage unit 504. The first video selection unit 509 outputs the read one of first video signal, second video signal, and third video signal to the first video reproduction unit 514.

Note that the first video selection unit 509 may select one of the first video signal to be reproduced together with the first sound signal and the second video signal to be reproduced together with the second sound signal based on the surrounding information. When one person is present around the speaker 11, the first video selection unit 509 may select the second video signal. In addition, when two or more persons are present around the speaker 11 and two or more persons are not having a conversation, the first video selection unit 509 may select the second video signal.

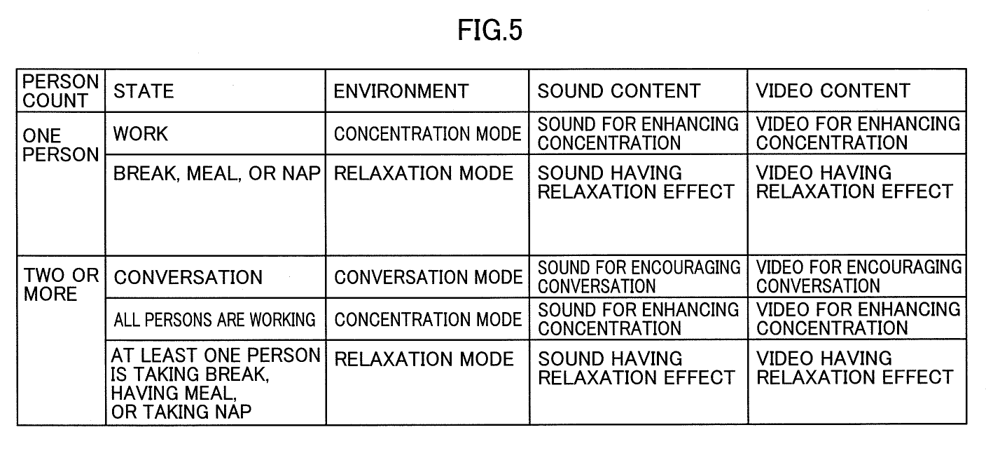

FIG. 5 is a diagram illustrating a relationship among the number of persons around the speaker 11, the state of the persons around the speaker 11, the sound content to be reproduced, and the video content to be reproduced in the first embodiment.

As illustrated in FIG. 5, when two or more persons are present around the speaker 11 and two or more persons are having a conversation, the mode provided to the two or more persons is the conversation mode, and the first sound signal that is the sound for encouraging conversation and the first video signal that is the video for encouraging conversation are selected.

Further, when two or more persons are present around the speaker 11 and all of the two or more persons are working, the mode provided to the two or more persons is a concentration mode, and the third sound signal that is a sound for enhancing concentration and the third video signal that is a video for enhancing concentration are selected.

Further, when two or more persons are present around the speaker 11 and none of the two or more persons is working (that is, at least one of the two or more persons is taking a break, having a meal, or taking a nap), the mode provided to the two or more persons is a relaxation mode, and the second sound signal that is a sound having a relaxation effect and the second video signal that is a video having a relaxation effect are selected.

Further, when one person is present around the speaker 11 and the one person is working, the mode provided to the one person is the concentration mode, and the third sound signal that is a sound for enhancing concentration and the third video signal that is a video for enhancing concentration are selected.

Further, when one person is present around the speaker 11 and the one person is not working (that is, the one person is taking a break, having a meal, or taking a nap), the mode provided to the one person is a relaxation mode, and the second sound signal that is a sound having a relaxation effect and the second video signal that is a video having a relaxation effect are selected.

The second video selection unit 510 selects one of the first video signal, the second video signal, and the third video signal according to the instruction from the reproduction control unit 502. The second video selection unit 510 selects one of the first video signal, the second video signal, and the third video signal based on the surrounding information. Note that the selection method of the second video selection unit 510 is the same as the selection method of the first video selection unit 509. The second video selection unit 510 reads the selected one of first video signal, second video signal, and third video signal from the second video storage unit 505. The second video selection unit 510 outputs the read one of first video signal, second video signal, and third video signal to the second video reproduction unit 515.

The third video selection unit 511 selects one of the first video signal, the second video signal, and the third video signal according to the instruction from the reproduction control unit 502. The third video selection unit 511 selects one of the first video signal, the second video signal, and the third video signal based on the surrounding information. Note that the selection method of the third video selection unit 511 is the same as the selection method of the first video selection unit 509. The third video selection unit 511 reads the selected one of first video signal, second video signal, and third video signal from the third video storage unit 506. The third video selection unit 511 outputs the read one of first video signal, second video signal, and third video signal to the third video reproduction unit 516.

The fourth video selection unit 512 selects one of the first video signal, the second video signal, and the third video signal according to the instruction from the reproduction control unit 502. The fourth video selection unit 512 selects one of the first video signal, the second video signal, and the third video signal based on the surrounding information. Note that the selection method of the fourth video selection unit 512 is the same as the selection method of the first video selection unit 509. The fourth video selection unit 512 reads the selected one of first video signal, second video signal, and third video signal from the fourth video storage unit 507. The fourth video selection unit 512 outputs the read one of first video signal, second video signal, and third video signal to the fourth video reproduction unit 517.

The sound reproduction unit 513 reproduces any one of the first sound signal, the second sound signal, and the third sound signal selected by the sound selection unit 508, and outputs the reproduced sound signal to the speaker 11. Note that the sound reproduction unit 513 may reproduce either the first sound signal or the second sound signal selected by the sound selection unit 508 and output the reproduced sound signal to the speaker 11.

The first video reproduction unit 514 reproduces one of the first video signal, the second video signal, and the third video signal selected by the first video selection unit 509, and outputs the reproduced video signal to the first display 6. Note that the first video reproduction unit 514 may reproduce either the first video signal or the second video signal selected by the first video selection unit 509, and output the reproduced video signal to the first display 6.

The second video reproduction unit 515 reproduces one of the first video signal, the second video signal, and the third video signal selected by the second video selection unit 510, and outputs the reproduced video signal to the second display 7. Note that the second video reproduction unit 515 may reproduce either the first video signal or the second video signal selected by the second video selection unit 510, and output the reproduced video signal to the second display 7.

The third video reproduction unit 516 reproduces one of the first video signal, the second video signal, and the third video signal selected by the third video selection unit 511, and outputs the reproduced video signal to the third display 8. Note that the third video reproduction unit 516 may reproduce either the first video signal or the second video signal selected by the third video selection unit 511, and output the reproduced video signal to the third display 8.

The fourth video reproduction unit 517 reproduces one of the first video signal, the second video signal, and the third video signal selected by the fourth video selection unit 512, and outputs the reproduced video signal to the fourth display 9. Note that the fourth video reproduction unit 517 may reproduce either the first video signal or the second video signal selected by the fourth video selection unit 512, and output the reproduced video signal to the fourth display 9.

The reproduction device 5 is connected to the amplifier 10 itself or a hub (not illustrated) such as a communication device or a server in a wired or wireless manner so that the first sound signal, the second sound signal, or the third sound signal can be input to the amplifier 10. The reproduction device 5 may be communicably connected to the amplifier 10 via a network. The reproduction device 5 outputs the first sound signal, the second sound signal, or the third sound signal to the amplifier 10.

The amplifier 10 is provided inside the housing 101. The amplifier 10 amplifies the first sound signal, the second sound signal, or the third sound signal input from the sound reproduction unit 513 of the reproduction device 5.

The speaker 11 is provided inside the housing 101. The speaker 11 converts the first sound signal, the second sound signal, or the third sound signal amplified by the amplifier 10 into a first sound, a second sound, or a third sound, and emits the first sound, the second sound, or the third sound to the periphery of the housing 101. Note that the amplifier 10 and the speaker 11 may be provided outside the housing 101.

The reproduction device 5 is connected to the plurality of displays (first display 6 to fourth display 9) or a hub (not illustrated) such as a communication device or a server in a wired or wireless manner such that the first video signal, the second video signal, or the third video signal can be input to the plurality of displays (first display 6 to fourth display 9). The reproduction device 5 may be communicably connected to each of a plurality of displays (first display 6 to fourth display 9) via a network. The reproduction device 5 outputs the first video signal, the second video signal, or the third video signal to each of the plurality of displays (first display 6 to fourth display 9).

The first display 6 displays the first video signal, the second video signal, or the third video signal input from the first video reproduction unit 514 of the reproduction device 5.

The second display 7 displays the first video signal, the second video signal, or the third video signal input from the second video reproduction unit 515 of the reproduction device 5.

The third display 8 displays the first video signal, the second video signal, or the third video signal input from the third video reproduction unit 516 of the reproduction device 5.

The fourth display 9 displays the first video signal, the second video signal, or the third video signal input from the fourth video reproduction unit 517 of the reproduction device 5.

Note that in the first embodiment, the housing 101 has a quadrangular prism shape, but the present disclosure is not particularly limited thereto, and may have a polygonal prism shape such as a triangular prism shape or a pentagonal prism shape. In addition, in the present first embodiment, the reproduction fixture 100 includes four cameras and four displays, but the present disclosure is not particularly limited thereto, and may include two or more cameras and two or more displays.

Further, in the first embodiment, the reproduction fixture 100 includes four cameras, but the present disclosure is not particularly limited thereto. The reproduction fixture 100 may include one camera capable of imaging the surroundings of the reproduction fixture 100. In this case, the camera may be, for example, an omnidirectional camera.

Next, reproduction processing by the reproduction device 5 according to the first embodiment of the present disclosure will be described.

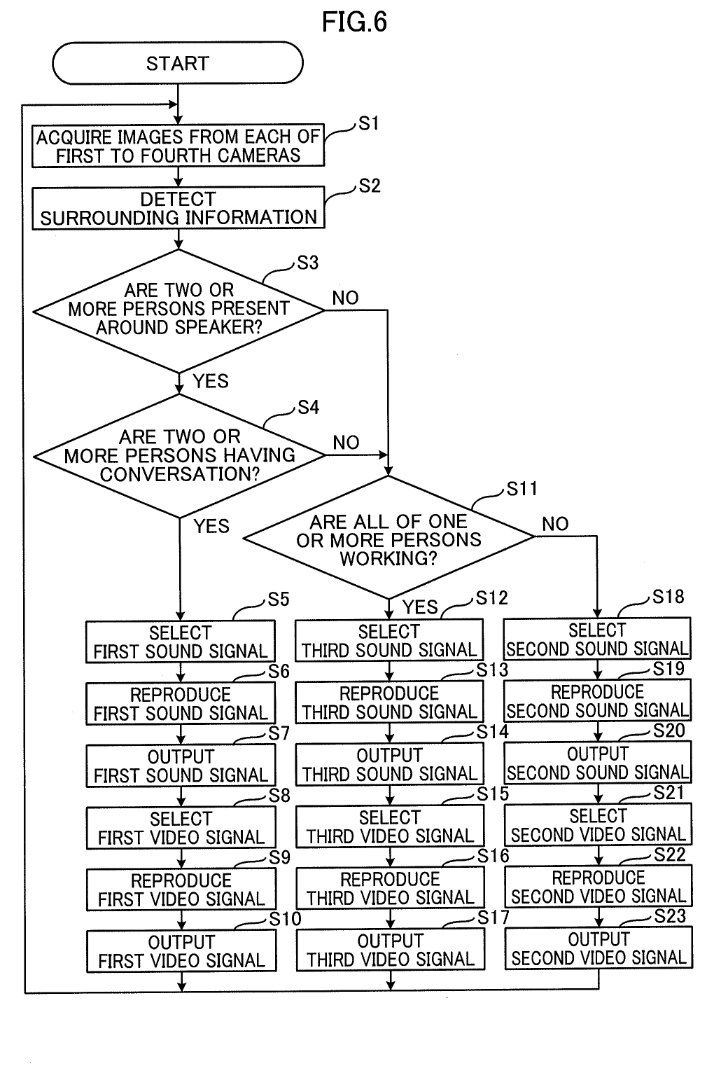

FIG. 6 is a flowchart for describing reproduction processing by the reproduction device 5 according to the first embodiment of the present disclosure.

First, in step S1, the detection unit 501 acquires images from each of the first camera 1 to the fourth camera 4.

Next, in step S2, the detection unit 501 detects surrounding information indicating a surrounding state of the speaker 11 based on the plurality of acquired images. Here, the surrounding information includes first information indicating the number of one or more persons present around the speaker 11, second information indicating whether or not two or more persons present around the speaker 11 are having a conversation, and third information indicating whether or not one or more persons present around the speaker 11 are working.

Next, in step S3, the reproduction control unit 502 determines whether or not two or more persons are present around the speaker 11 based on the first information included in the surrounding information.

Here, when it is determined that less than two persons are present around the speaker 11, that is, when it is determined that no more than one person is present around the speaker 11 (NO in step S3), the processing proceeds to step S11.

On the other hand, when it is determined that two or more persons are present around the speaker 11 (YES in step S3), in step S4, the reproduction control unit 502 determines whether or not two or more persons present around the speaker 11 are having a conversation based on the second information included in the surrounding information.

Here, when it is determined that two or more persons present around the speaker 11 are not having a conversation (NO in step S4), the processing proceeds to step S11.

On the other hand, when it is determined that two or more persons present around the speaker 11 are having a conversation (YES in step S4), the sound selection unit 508 selects the first sound signal for encouraging conversation in step S5. Note that, when it is determined that two or more persons present around the speaker 11 are having a conversation, the reproduction control unit 502 instructs the sound selection unit 508 to select the first sound signal. The sound selection unit 508 reads the first sound signal from the sound storage unit 503 and outputs the first sound signal to the sound reproduction unit 513.

Next, in step S6, the sound reproduction unit 513 reproduces the first sound signal selected by the sound selection unit 508 at a predetermined volume.

Next, in step S7, the sound reproduction unit 513 outputs the reproduced first sound signal to the amplifier 10. The amplifier 10 amplifies the first sound signal reproduced by the sound reproduction unit 513 and outputs the amplified first sound signal to the speaker 11. The speaker 11 converts the first sound signal amplified by the amplifier 10 into a first sound and emits the converted first sound.

Thus, since the first sound for encouraging conversation is emitted to the surroundings of the speaker 11, it is possible to encourage two or more persons around the speaker 11 to have a conversation.

Next, in step S8, the first video selection unit 509, the second video selection unit 510, the third video selection unit 511, and the fourth video selection unit 512 select the first video signal for encouraging conversation. Note that, when it is determined that two or more persons present around the speaker 11 are having a conversation, the reproduction control unit 502 instructs the first video selection unit 509, the second video selection unit 510, the third video selection unit 511, and the fourth video selection unit 512 to select the first video signal. The first video selection unit 509 reads the first video signal from the first video storage unit 504, and outputs the first video signal to the first video reproduction unit 514. The second video selection unit 510 reads the first video signal from the second video storage unit 505, and outputs the first video signal to the second video reproduction unit 515. The third video selection unit 511 reads the first video signal from the third video storage unit 506, and outputs the first video signal to the third video reproduction unit 516. The fourth video selection unit 512 reads the first video signal from the fourth video storage unit 507, and outputs the first video signal to the fourth video reproduction unit 517.

Next, in step S9, the first video reproduction unit 514, the second video reproduction unit 515, the third video reproduction unit 516, and the fourth video reproduction unit 517 reproduce the first video signal selected by the first video selection unit 509, the second video selection unit 510, the third video selection unit 511, and the fourth video selection unit 512.

Next, in step S10, the first video reproduction unit 514, the second video reproduction unit 515, the third video reproduction unit 516, and the fourth video reproduction unit 517 output the reproduced first video signal to the first display 6, the second display 7, the third display 8, and the fourth display 9. The first display 6 displays the first video signal reproduced by the first video reproduction unit 514. The second display 7 displays the first video signal reproduced by the second video reproduction unit 515. The third display 8 displays the first video signal reproduced by the third video reproduction unit 516. The fourth display 9 displays the first video signal reproduced by the fourth video reproduction unit 517.

Thus, the first video signal for encouraging the conversation is displayed on the first display 6, the second display 7, the third display 8, and the fourth display 9, so that the conversation can be urged to two or more persons around the speaker 11.

On the other hand, when it is determined in step S3 that less than two persons are present around the speaker 11, that is, when it is determined that no more than one person is present around the speaker 11 (NO in step S3), or if it is determined in step S4 that two or more persons present around the speaker 11 are not having a conversation (NO in step S4), then in step S11, the reproduction control unit 502 determines whether or not all of the one or more persons present around the speaker 11 are working, based on the third information included in the surrounding information.

Here, when it is determined that all of the one or more persons present around the speaker 11 are working (YES in step S11), the sound selection unit 508 selects the third sound signal for enhancing concentration in step S12. Note that, when it is determined that all of the one or more persons present around the speaker 11 are working, the reproduction control unit 502 instructs the sound selection unit 508 to select the third sound signal. The sound selection unit 508 reads the third sound signal from the sound storage unit 503 and outputs the third sound signal to the sound reproduction unit 513.

Next, in step S13, the sound reproduction unit 513 reproduces the third sound signal selected by the sound selection unit 508 at a predetermined volume.

Next, in step S14, the sound reproduction unit 513 outputs the reproduced third sound signal to the amplifier 10. The amplifier 10 amplifies the third sound signal reproduced by the sound reproduction unit 513 and outputs the amplified third sound signal to the speaker 11. The speaker 11 converts the third sound signal amplified by the amplifier 10 into a third sound and emits the converted third sound.

Thus, since the third sound for enhancing the concentration is emitted to the periphery of the speaker 11, the concentration of one or more persons working around the speaker 11 can be enhanced.

Next, in step S15, the first video selection unit 509, the second video selection unit 510, the third video selection unit 511, and the fourth video selection unit 512 select the third video signal for enhancing the concentration. Note that, when it is determined that all of one or more persons present around the speaker 11 are working, the reproduction control unit 502 instructs the first video selection unit 509, the second video selection unit 510, the third video selection unit 511, and the fourth video selection unit 512 to select the third video signal. The first video selection unit 509 reads the third video signal from the first video storage unit 504, and outputs the third video signal to the first video reproduction unit 514. The second video selection unit 510 reads the third video signal from the second video storage unit 505, and outputs the third video signal to the second video reproduction unit 515. The third video selection unit 511 reads the third video signal from the third video storage unit 506, and outputs the third video signal to the third video reproduction unit 516. The fourth video selection unit 512 reads the third video signal from the fourth video storage unit 507, and outputs the third video signal to the fourth video reproduction unit 517.

Next, in step S16, the first video reproduction unit 514, the second video reproduction unit 515, the third video reproduction unit 516, and the fourth video reproduction unit 517 reproduce the third video signal selected by the first video selection unit 509, the second video selection unit 510, the third video selection unit 511, and the fourth video selection unit 512.

Next, in step S17, the first video reproduction unit 514, the second video reproduction unit 515, the third video reproduction unit 516, and the fourth video reproduction unit 517 output the reproduced third video signal to the first display 6, the second display 7, the third display 8, and the fourth display 9. The first display 6 displays the third video signal reproduced by the first video reproduction unit 514. The second display 7 displays the third video signal reproduced by the second video reproduction unit 515. The third display 8 displays the third video signal reproduced by the third video reproduction unit 516. The fourth display 9 displays the third video signal reproduced by the fourth video reproduction unit 517.

Thus, since the third video signal for enhancing the concentration is displayed on the first display 6, the second display 7, the third display 8, and the fourth display 9, it is possible to enhance the concentration of one or more persons working around the speaker 11.

On the other hand, when it is determined in step S11 that all of the one or more persons present around the speaker 11 are not working, that is, when a person who is not working is present among the one or more persons present around the speaker 11 (NO in step S11), the sound selection unit 508 selects the second sound signal having a relaxation effect in step S18. Note that, when it is determined that all of the one or more persons present around the speaker 11 are not working, the reproduction control unit 502 instructs the sound selection unit 508 to select the second sound signal. The sound selection unit 508 reads the second sound signal from the sound storage unit 503 and outputs the second sound signal to the sound reproduction unit 513.

A person who is not having a conversation or working is estimated to be taking a break, having a meal, or taking a nap. Thus, when it is determined that all of the one or more persons present around the speaker 11 are not working, the sound selection unit 508 selects the second sound signal having the relaxation effect.

Next, in step S19, the sound reproduction unit 513 reproduces the second sound signal selected by the sound selection unit 508 at a predetermined volume.

Next, in step S20, the sound reproduction unit 513 outputs the reproduced second sound signal to the amplifier 10. The amplifier 10 amplifies the second sound signal reproduced by the sound reproduction unit 513 and outputs the amplified second sound signal to the speaker 11. The speaker 11 converts the second sound signal amplified by the amplifier 10 into a second sound and emits the converted second sound.

Thus, since the second sound having the relaxation effect is emitted to the surroundings of the speaker 11, it is possible to relax one or more persons who are taking a break, having a meal, or taking a nap around the speaker 11.

Next, in step S21, the first video selection unit 509, the second video selection unit 510, the third video selection unit 511, and the fourth video selection unit 512 select the second video signal having a relaxation effect. Note that, when it is determined that all of one or more persons present around the speaker 11 are not working, the reproduction control unit 502 instructs the first video selection unit 509, the second video selection unit 510, the third video selection unit 511, and the fourth video selection unit 512 to select the second video signal. The first video selection unit 509 reads the second video signal from the first video storage unit 504, and outputs the second video signal to the first video reproduction unit 514. The second video selection unit 510 reads the second video signal from the second video storage unit 505, and outputs the second video signal to the second video reproduction unit 515. The third video selection unit 511 reads the second video signal from the third video storage unit 506, and outputs the second video signal to the third video reproduction unit 516. The fourth video selection unit 512 reads the second video signal from the fourth video storage unit 507, and outputs the second video signal to the fourth video reproduction unit 517.

Next, in step S22, the first video reproduction unit 514, the second video reproduction unit 515, the third video reproduction unit 516, and the fourth video reproduction unit 517 reproduce the second video signal selected by the first video selection unit 509, the second video selection unit 510, the third video selection unit 511, and the fourth video selection unit 512.

Next, in step S23, the first video reproduction unit 514, the second video reproduction unit 515, the third video reproduction unit 516, and the fourth video reproduction unit 517 output the reproduced second video signal to the first display 6, the second display 7, the third display 8, and the fourth display 9. The first display 6 displays the second video signal reproduced by the first video reproduction unit 514. The second display 7 displays the second video signal reproduced by the second video reproduction unit 515. The third display 8 displays the second video signal reproduced by the third video reproduction unit 516. The fourth display 9 displays the second video signal reproduced by the fourth video reproduction unit 517.

Thus, the second video signal having a relaxation effect is displayed on the first display 6, the second display 7, the third display 8, and the fourth display 9, so that one or more persons who are taking a break, having a meal, or taking a nap around the speaker 11 can be relaxed.

It is said that a sound including a conversation frequency range has an effect of encouraging people to have a conversation. Thus, when two or more persons are present having a conversation around the speaker 11, it is possible to encourage the two or more persons to have a conversation by reproducing the first sound signal including the conversation frequency range. Further, it is said that a sound that does not include a conversation frequency range has an effect of relaxing a person. Thus, when one person is present around the speaker 11 or when two or more persons are present who are not having a conversation around the speaker, it is possible to relax the one person or two or more persons by reproducing the second sound signal not including the conversation frequency range. Therefore, it is possible to provide an environment suitable for the action of one or more persons.

Further, it is said that a nonstationary sound including a conversation frequency range has an effect of encouraging people to have a conversation. Thus, when two or more persons are present around the speaker 11 and the two or more persons are having a conversation, the first sound signal that is a nonstationary sound including the conversation frequency range is reproduced, so that it is possible to further encourage the conversation of the two or more persons who are having a conversation. Further, it is said that a nonstationary sound not including a conversation frequency range has an effect of relaxing a person. Thus, when one person is present around the speaker 11 and the one person is not working, or when two or more persons are present around the speaker 11 and the two or more persons are not working, the second sound signal that is a nonstationary sound not including the conversation frequency range is reproduced, so that the one person or two or more persons who are not working can be relaxed. Further, a stationary sound including a conversation frequency range is said to have an effect of increasing concentration of a person. Thus, when one person is present around the speaker 11 and the one person is working, or when two or more persons are present around the speaker 11 and the two or more persons are working, the third sound signal that is a stationary sound including the conversation frequency range is reproduced, and thus it is possible to enhance the concentration of the one person or two or more persons who are working.

Note that, when no person is present around the speaker 11, the reproduction control unit 502 determines that less than two persons are present around the speaker 11 (NO in step S3), and determines that all of the one or more persons around the speaker 11 are not working (NO in step S11). Thus, when no person is present around the speaker 11, the second sound signal and the second video signal are reproduced.

In addition, before step S3, the reproduction control unit 502 may determine whether or not one or more persons are present around the speaker 11 based on the first information included in the surrounding information. Then, when it is determined that one or more persons are present around the speaker 11, the processing may proceed to step S3. In addition, when it is determined that less than one person is present around the speaker 11, that is, when it is determined that no person is present around the speaker 11, the processing may return to step S1. Thus, when it is determined in step S3 that less than two persons are present around the speaker 11, one person is present around the speaker 11.

In the first embodiment, the first display 6 to the fourth display 9 display the same video signal. Therefore, the reproduction device 5 may include only the first video storage unit 504, the first video selection unit 509, and the first video reproduction unit 514, and need not include the second video storage unit 505 to the fourth video storage unit 507, the second video selection unit 510 to the fourth video selection unit 512, and the second video reproduction unit 515 to the fourth video reproduction unit 517. In this case, the first video reproduction unit 514 outputs the reproduced first video signal, second video signal, or third video signal to the first display 6 to the fourth display 9.

In the first embodiment, the surrounding information includes the first information indicating the number of one or more persons present around the speaker 11, the second information indicating whether or not two or more persons present around the speaker 11 are having a conversation, and the third information indicating whether or not one or more persons present around the speaker 11 are working, but the present disclosure is not particularly limited thereto. The surrounding information may include only the first information and the second information. When it is determined that less than two persons are present around the speaker 11, when it is determined that one person is present around the speaker 11, or when it is determined that two or more persons are not having a conversation, the sound selection unit 508 may select the second sound signal. In addition, when it is determined that less than two persons are present around the speaker 11, when it is determined that one person is present around the speaker 11, or when it is determined that two or more persons are not having a conversation, the first video selection unit 509, the second video selection unit 510, the third video selection unit 511, and the fourth video selection unit 512 may select the second video signal.

In addition, the surrounding information may include only the first information. When it is determined that two or more persons are present around the speaker 11, the sound selection unit 508 may select the first sound signal. In addition, when it is determined that two or more persons are present around the speaker 11, the first video selection unit 509, the second video selection unit 510, the third video selection unit 511, and the fourth video selection unit 512 may select the first video signal. In addition, when it is determined that less than two persons are present around the speaker 11 or when it is determined that one person is present around the speaker 11, the sound selection unit 508 may select the second sound signal. In addition, when it is determined that less than two persons are present around the speaker 11, or when it is determined that one person is present around the speaker 11, the first video selection unit 509, the second video selection unit 510, the third video selection unit 511, and the fourth video selection unit 512 may select the second video signal.

In the first embodiment, when all the one or more persons around the speaker 11 are working, the third sound signal and the third video signal for enhancing concentration are selected. However, the present disclosure is not particularly limited thereto, and the second sound signal and the second video signal having a relaxation effect may be selected. In addition, the user may select which of the third sound signal and the second sound signal is to be reproduced when all of one or more persons present around the speaker 11 are working. In addition, the user may select which of the third video signal and the second video signal is to be reproduced when all of one or more persons present around the speaker 11 are working.

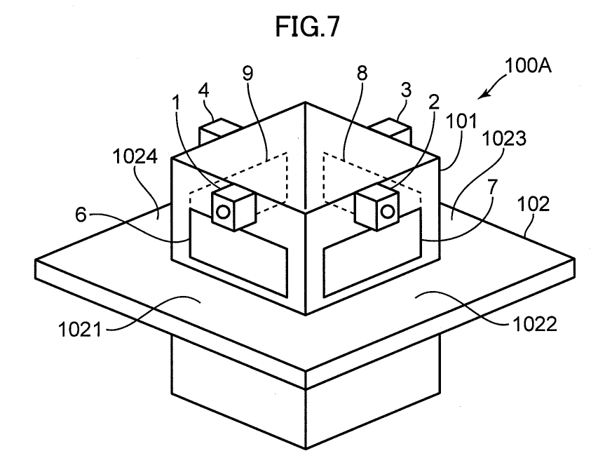

FIG. 7 is a view illustrating an external configuration of the reproduction fixture 100A according to a modification example of the first embodiment.

In the modification example of the first embodiment, the reproduction fixture 100A may include a table 102. One or more tables may be disposed in front of the one or more displays, respectively. Tables 102 are disposed so as to surround the four side surfaces of the housing 101. The tables 102 include a first table 1021, a second table 1022, a third table 1023, and a fourth table 1024. The first table 1021 is disposed in front of the first display 6, the second table 1022 is disposed in front of the second display 7, the third table 1023 is disposed in front of the third display 8, and the fourth table 1024 is disposed in front of the fourth display 9.

Each of the first table 1021, the second table 1022, the third table 1023, and the fourth table 1024 is used by one person. The height of each of the first table 1021, the second table 1022, the third table 1023, and the fourth table 1024 is set to a height that can be used in a state where a person stands or a height that can be used in a state where a person sits on a chair.

The first display 6 is disposed at a position visible from a person who uses the first table 1021, the second display 7 is disposed at a position visible from a person who uses the second table 1022, the third display 8 is disposed at a position visible from a person who uses the third table 1023, and the fourth display 9 is disposed at a position visible from a person who uses the fourth table 1024.

The first camera 1 images a person who is in front of the first display 6 and uses the first table 1021. The second camera 2 images a person who is in front of the second display 7 and uses the second table 1022. The third camera 3 images a person who is in front of the third display 8 and uses the third table 1023. The fourth camera 4 images a person who is in front of the fourth display 9 and uses the fourth table 1024.

The first information indicates the number of one or more persons who use each of one or more tables. The second information indicates whether or not two or more persons using each of the one or more tables are having a conversation.

Note that the tables need not necessarily be provided on the four surfaces of the housing 101, and a wall, a chair, or a sofa may be provided on any surface.

In addition, the sound selection unit 508 may change the volume of either the selected first sound signal or second sound signal. In addition, the first video selection unit 509, the second video selection unit 510, the third video selection unit 511, and the fourth video selection unit 512 may change the luminance of one of the selected first video signal and second video signal. For example, the sound selection unit 508 may reduce the volume of the second sound signal below the volume of the first sound signal. Further, for example, the first video selection unit 509, the second video selection unit 510, the third video selection unit 511, and the fourth video selection unit 512 may reduce the luminance of the second video signal below the luminance of the first video signal.

In addition, the sound selection unit 508 may reduce the volume of the second sound signal below the volume of the third sound signal. In addition, the first video selection unit 509, the second video selection unit 510, the third video selection unit 511, and the fourth video selection unit 512 may reduce the luminance of the second video signal below the luminance of the third video signal.

In addition, the reproduction control unit 502 may further acquire time information indicating the current time. The sound selection unit 508 may select the second sound signal corresponding to the current time based on the surrounding information and the time information. In addition, the first video selection unit 509, the second video selection unit 510, the third video selection unit 511, and the fourth video selection unit 512 may select the second video signal corresponding to the current time based on the surrounding information and the time information.

For example, if the current time is the morning time zone, the sound selection unit 508 may select the second sound signal indicating the bird chirping actively in the morning time zone. In addition, for example, if the current time is the daytime time zone, the sound selection unit 508 may select the second sound signal indicating the bird chirping gently in the daytime time zone. In addition, for example, if the current time is in the evening time zone, the sound selection unit 508 may select the second sound signal indicating the insect chirping in the evening time zone.

In addition, for example, if the current time is the morning time zone, the first video selection unit 509, the second video selection unit 510, the third video selection unit 511, and the fourth video selection unit 512 may select the second video signal indicating the natural scenery in the morning time zone. In addition, for example, if the current time is in the daytime time zone, the first video selection unit 509, the second video selection unit 510, the third video selection unit 511, and the fourth video selection unit 512 may select the second video signal indicating the natural scenery in the daytime time zone. In addition, for example, if the current time is in the evening time zone, the first video selection unit 509, the second video selection unit 510, the third video selection unit 511, and the fourth video selection unit 512 may select the second video signal indicating the natural scenery in the evening time zone. In addition, for example, if the current time is in the night time zone, the first video selection unit 509, the second video selection unit 510, the third video selection unit 511, and the fourth video selection unit 512 may reduce the luminance of the second video signal below the preset reference luminance of the second video signal.

As described above, since the second sound signal and the second video signal of the type corresponding to the current time are selected, it is possible to provide an environment in which the flow of time is felt like being in a natural environment.

In the first embodiment, one speaker 11 is provided in the reproduction fixture 100, but the present disclosure is not particularly limited thereto, and a plurality of speakers may be provided. The reproduction fixture 100 may include speakers on each of the four side surfaces of the housing 101.

### Second embodiment

A reproduction fixture of a second embodiment further includes a lighting device in addition to the configuration of the reproduction fixture 100 of the first embodiment.

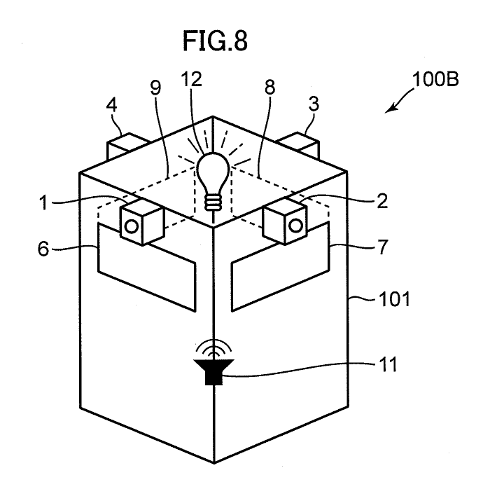

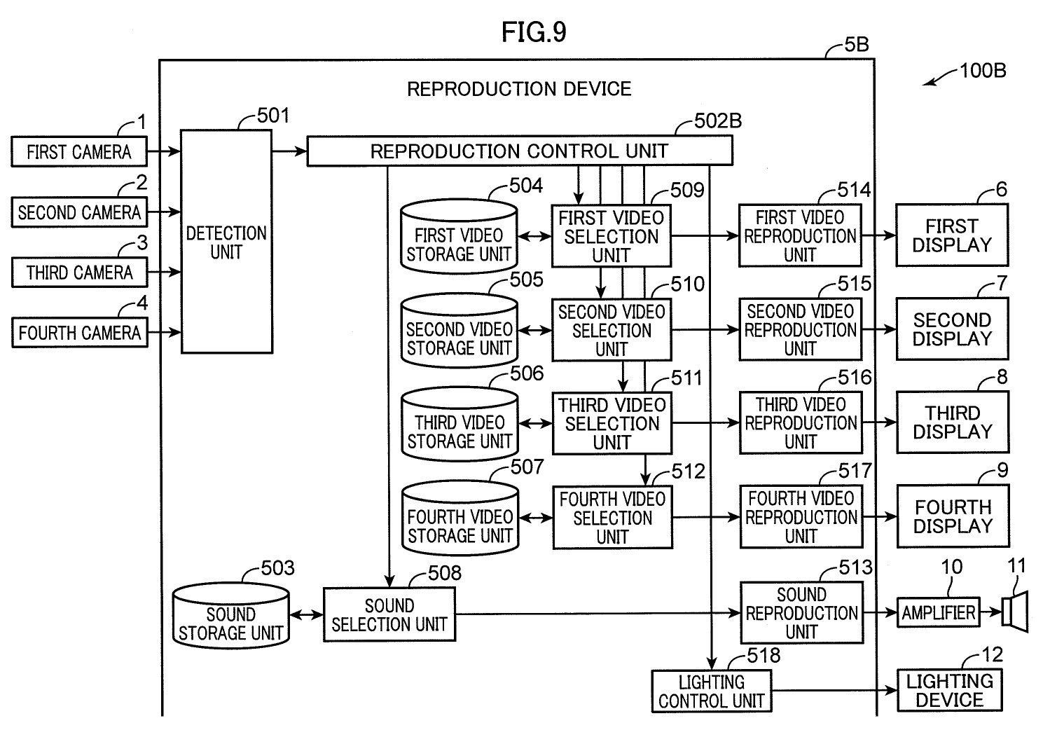

FIG. 8 is a view illustrating an external configuration of a reproduction fixture 100B according to the second embodiment, and FIG. 9 is a block diagram illustrating a configuration of a reproduction device 5B according to the second embodiment.

The reproduction fixture 100B includes a first camera 1, a second camera 2, a third camera 3, a fourth camera 4, a reproduction device 5B, a first display 6, a second display 7, a third display 8, a fourth display 9, an amplifier 10, a speaker 11, a lighting device 12, and a housing 101.

Note that, in the second embodiment, the same configuration as that in the first embodiment will be denoted by the same reference sign as that in the first embodiment, and will be omitted from description.

The lighting device 12 is, for example, a light emitting diode (LED), and is disposed near the speaker 11. More specifically, the lighting device 12 is disposed near an opening formed in an upper surface of the housing 101. The lighting device 12 is disposed at a position visible from a person around the speaker 11. The lighting device 12 emits light at a color temperature and illuminance based on a control signal from the reproduction device 5B.

The reproduction device 5B includes a detection unit 501, a reproduction control unit 502B, a sound storage unit 503, a first video storage unit 504, a second video storage unit 505, a third video storage unit 506, a fourth video storage unit 507, a sound selection unit 508, a first video selection unit 509, a second video selection unit 510, a third video selection unit 511, a fourth video selection unit 512, a sound reproduction unit 513, a first video reproduction unit 514, a second video reproduction unit 515, a third video reproduction unit 516, a fourth video reproduction unit 517, and a lighting control unit 518.

Based on the surrounding information, the reproduction control unit 502B instructs the lighting control unit 518 to control the lighting device 12 in any of a conversation mode for encouraging conversation, a relaxation mode for relaxing, and a concentration mode for enhancing concentration.

When two or more persons are present around the speaker 11 and the two or more persons are having a conversation, the reproduction control unit 502B instructs the lighting control unit 518 to control the lighting device 12 in the conversation mode.

Further, when one person is present around the speaker 11 and the one person is not working, the reproduction control unit 502B instructs the lighting control unit 518 to control the lighting device 12 in the relaxation mode. Further, when two or more persons are present around the speaker 11 and two or more persons are not working, the reproduction control unit 502B instructs the lighting control unit 518 to control the lighting device 12 in the relaxation mode.

Further, when one person is present around the speaker 11 and the one person is working, the reproduction control unit 502B instructs the lighting control unit 518 to control the lighting device 12 in the concentration mode. Further, when two or more persons are present around the speaker 11 and two or more persons are working, the reproduction control unit 502B instructs the lighting control unit 518 to control the lighting device 12 in the concentration mode.

Note that the reproduction control unit 502B instructs the sound selection unit 508, the first video selection unit 509, the second video selection unit 510, the third video selection unit 511, and the fourth video selection unit 512 similarly to the first embodiment.

The lighting control unit 518 determines at least one of the color temperature or the illuminance of the lighting device 12 according to the instruction from the reproduction control unit 502B.

The lighting control unit 518 determines at least one of the color temperature or the illuminance of the lighting device 12 disposed near the speaker 11 based on the surrounding information, and outputs a control signal for controlling the lighting device 12 to the lighting device 12 based on at least one of the determined color temperature or illuminance.

When instructed to control the lighting device 12 in the conversation mode from the reproduction control unit 502B, the lighting control unit 518 determines the color temperature of the lighting device 12 as a first color temperature, determines the illuminance of the lighting device 12 as a first illuminance, and outputs a control signal for controlling the lighting device 12 to the lighting device 12 based on the determined first color temperature and first illuminance. The first color temperature is, for example, 2200 Kelvin to 2500 Kelvin, and the first illuminance is, for example, 75 lux to 100 lux.

Further, when an instruction to control the lighting device 12 in the relaxation mode is given from the reproduction control unit 502B, the lighting control unit 518 determines the color temperature of the lighting device 12 to be the second color temperature higher than the first color temperature, determines the illuminance of the lighting device 12 to be the second illuminance higher than the first illuminance, and outputs a control signal for controlling the lighting device 12 to the lighting device 12 based on the determined second color temperature and second illuminance. The second color temperature is, for example, 2500 Kelvin to 4000 Kelvin, and the second illuminance is, for example, 100 lux to 500 lux.

Further, when an instruction to control the lighting device 12 in the concentration mode is given from the reproduction control unit 502B, the lighting control unit 518 determines the color temperature of the lighting device 12 to be a third color temperature higher than the second color temperature, determines the illuminance of the lighting device 12 to be a third illuminance higher than the second illuminance, and outputs a control signal for controlling the lighting device 12 to the lighting device 12 based on the determined third color temperature and third illuminance. The third color temperature is, for example, 4000 Kelvin to 6500 Kelvin, and the third illuminance is, for example, 500 lux to 1000 lux.

The reproduction device 5B is connected to the lighting device 12 itself or a hub (not illustrated) such as a communication device or a server in a wired or wireless manner so that a control signal can be input to the lighting device 12. The reproduction device 5B may be communicably connected to the lighting device 12 via a network. The reproduction device 5B outputs the control signal to the lighting device 12.

The lighting device 12 controls the color temperature and illuminance of the LED according to the control signal output by the lighting control unit 518.

In addition, when the lighting device 12 can switch between direct lighting and indirect lighting (building lighting), the lighting control unit 518 may determine whether to use direct lighting or indirect lighting according to the instruction from the reproduction control unit 502B. When an instruction to control the lighting device 12 in the conversation mode or the relaxation mode is given from the reproduction control unit 502B, the lighting control unit 518 may determine the lighting method to be indirect lighting. In addition, the lighting control unit 518 may determine the lighting method as direct lighting when instructed to control the lighting device 12 in the concentration mode from the reproduction control unit 502B.

In addition, the reproduction control unit 502B may further acquire the time information indicating the current time. The lighting control unit 518 may change at least one of the color temperature or the illuminance of the lighting device 12 depending on the current time based on the surrounding information and the time information.

### Third embodiment

A reproduction device of a third embodiment further acquires weather information regarding the current weather, selects the second sound signal corresponding to the current weather based on the surrounding information and the weather information, and selects the second video signal corresponding to the current weather based on the surrounding information and the weather information.

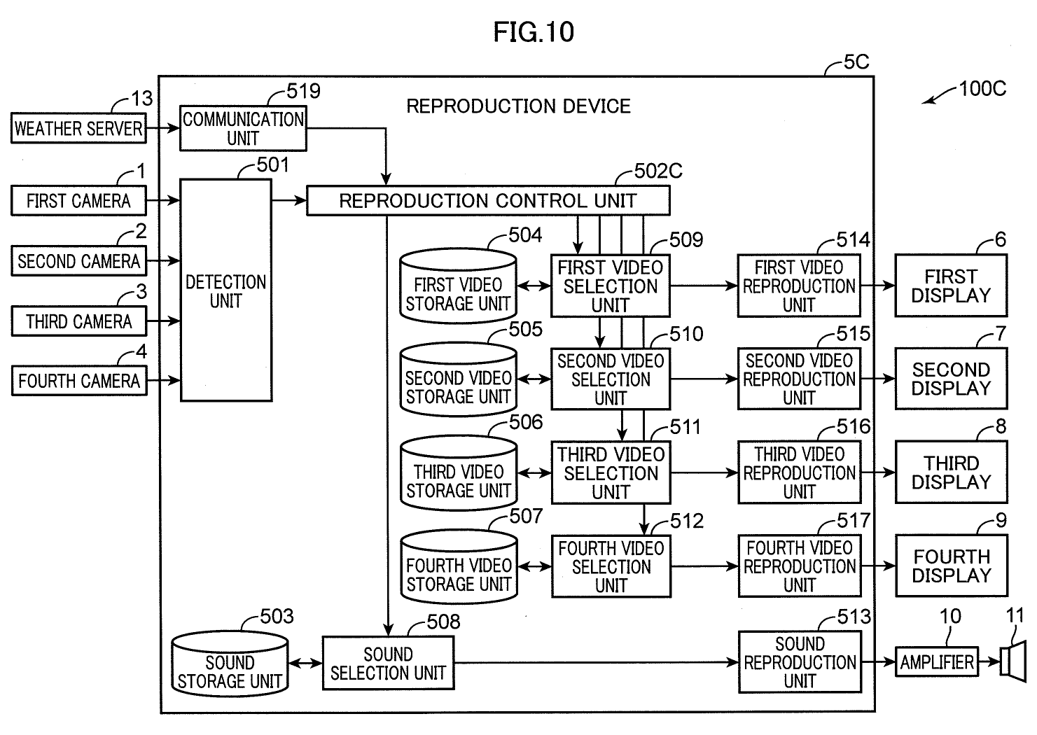

FIG. 10 is a block diagram illustrating a configuration of a reproduction device 5C according to the third embodiment.

The reproduction fixture 100C includes a first camera 1, a second camera 2, a third camera 3, a fourth camera 4, a reproduction device 5C, a first display 6, a second display 7, a third display 8, a fourth display 9, an amplifier 10, a speaker 11, and a housing 101 (not illustrated).

Note that, in the third embodiment, the same configuration as that in the first embodiment will be denoted by the same reference sign as that in the first embodiment, and will be omitted from description.

The weather server 13 provides weather information regarding the current weather in the area where the reproduction fixture 100C is disposed. The weather server 13 transmits weather information of the area where the reproduction fixture 100C is disposed to the reproduction device 5C.

The reproduction device 5C includes a detection unit 501, a reproduction control unit 502C, a sound storage unit 503, a first video storage unit 504, a second video storage unit 505, a third video storage unit 506, a fourth video storage unit 507, a sound selection unit 508, a first video selection unit 509, a second video selection unit 510, a third video selection unit 511, a fourth video selection unit 512, a sound reproduction unit 513, a first video reproduction unit 514, a second video reproduction unit 515, a third video reproduction unit 516, a fourth video reproduction unit 517, and a communication unit 519.

The communication unit 519 receives the weather information regarding the current weather from the weather server 13. The communication unit 519 transmits, to the weather server 13, request information for requesting weather information regarding the current weather in the area where the reproduction fixture 100C is disposed. The request information includes information indicating an area where the reproduction fixture 100C is disposed. Upon receiving the request information, the weather server 13 transmits weather information regarding the current weather of the area included in the request information to the reproduction device 5C. The communication unit 519 receives the weather information transmitted by the weather server 13.

The reproduction control unit 502C further acquires the weather information regarding the current weather. The sound selection unit 508 selects the second sound signal corresponding to the current weather based on the surrounding information and the weather information. In addition, the first video selection unit 509, the second video selection unit 510, the third video selection unit 511, and the fourth video selection unit 512 select the second video signal corresponding to the current weather based on the surrounding information and the weather information.

When one person is present around the speaker 11, the one person is not working, and the current weather in the area where the reproduction fixture 100C is disposed is sunny, the reproduction control unit 502C instructs the sound selection unit 508 to select the second sound signal corresponding to sunny weather. Further, when two or more persons are present around the speaker 11, two or more persons are not working, and the current weather in the area where the reproduction fixture 100C is disposed is sunny, the reproduction control unit 502C instructs the sound selection unit 508 to select the second sound signal corresponding to sunny weather. The second sound signal corresponding to sunny weather is the same as the second sound signal in the first embodiment, and does not include a sound of rainfall.

Further, when one person is present around the speaker 11, the one person is not working, and the current weather in the area where the reproduction fixture 100C is disposed is rainy, the reproduction control unit 502C instructs the sound selection unit 508 to select the second sound signal corresponding to rain. Further, when two or more persons are present around the speaker 11, two or more persons are not working, and the current weather in the area where the reproduction fixture 100C is disposed is rainy, the reproduction control unit 502C instructs the sound selection unit 508 to select the second sound signal corresponding to rain. The second sound signal corresponding to rain includes a sound of rainfall.

Further, when one person is present around the speaker 11, the one person is not working, and the current weather in the area where the reproduction fixture 100C is disposed is sunny, the reproduction control unit 502C instructs the first video selection unit 509, the second video selection unit 510, the third video selection unit 511, and the fourth video selection unit 512 to select the second video signal corresponding to sunny weather. Further, when two or more persons are present around the speaker 11, two or more persons are not working, and the current weather in the area where the reproduction fixture 100C is disposed is sunny, the reproduction control unit 502C instructs the first video selection unit 509, the second video selection unit 510, the third video selection unit 511, and the fourth video selection unit 512 to select the second video signal corresponding to sunny weather. The second video signal corresponding to sunny weather is the same as the second video signal in the first embodiment, and does not include a video of rainfall but includes a video of sunny weather.

Further, when one person is present around the speaker 11, the one person is not working, and the current weather in the area where the reproduction fixture 100C is disposed is rainy, the reproduction control unit 502C instructs the first video selection unit 509, the second video selection unit 510, the third video selection unit 511, and the fourth video selection unit 512 to select the second video signal corresponding to rain. Further, when two or more persons are present around the speaker 11, two or more persons are not working, and the current weather in the area where the reproduction fixture 100C is disposed is rainy, the reproduction control unit 502C instructs the first video selection unit 509, the second video selection unit 510, the third video selection unit 511, and the fourth video selection unit 512 to select the second video signal corresponding to rain. The second video signal corresponding to rain includes a video of rainfall.

The sound selection unit 508 selects one of the first sound signal, the second sound signal, and the third sound signal according to the instruction from the reproduction control unit 502. The sound selection unit 508 selects the second sound signal corresponding to the current weather based on the surrounding information and the weather information. When the current weather in the area where the reproduction fixture 100C is disposed is sunny, the sound selection unit 508 selects the second sound signal corresponding to sunny weather. When the current weather in the area where the reproduction fixture 100C is disposed is rainy, the sound selection unit 508 selects the second sound signal corresponding to rain.

The first video selection unit 509, the second video selection unit 510, the third video selection unit 511, and the fourth video selection unit 512 select any one of the first video signal, the second video signal, and the third video signal according to the instruction from the reproduction control unit 502. The first video selection unit 509, the second video selection unit 510, the third video selection unit 511, and the fourth video selection unit 512 select the second video signal corresponding to the current weather based on the surrounding information and the weather information. When the current weather in the area where the reproduction fixture 100C is disposed is sunny, the first video selection unit 509, the second video selection unit 510, the third video selection unit 511, and the fourth video selection unit 512 select the second video signal corresponding to sunny weather. When the current weather in the area where the reproduction fixture 100C is disposed is rainy, the first video selection unit 509, the second video selection unit 510, the third video selection unit 511, and the fourth video selection unit 512 select the second video signal corresponding to rain.

As described above, since the second sound signal and the second video signal corresponding to the current weather are selected, it is possible to provide an environment in which a change in weather is felt like being in a natural environment.

Note that when the current weather in the area where the reproduction fixture 100C is disposed is cloudy or snowy, the sound selection unit 508 may select the second sound signal corresponding to cloudy or snowy weather. The second sound signal corresponding to cloudiness or snow may be the same as the second sound signal corresponding to sunny weather.

In addition, when the current weather in the area where the reproduction fixture 100C is disposed is cloudy or snowy, the first video selection unit 509, the second video selection unit 510, the third video selection unit 511, and the fourth video selection unit 512 may select the second video signal corresponding to the cloudy or snowy weather. The second video signal corresponding to the cloudiness includes a video in which the sky is cloudy. The second video signal corresponding to snow includes a video in which snow is falling.

In addition, the weather information may include a precipitation amount per predetermined time. The predetermined time is, for example, one hour. The sound selection unit 508 may change the volume of the second sound signal depending on the precipitation amount. For example, the sound selection unit 508 may link the precipitation amount with the volume of the second sound signal, and may increase the volume of the second sound signal as the precipitation amount increases.

### Fourth embodiment

A reproduction fixture according to a fourth embodiment is different from the configuration of the reproduction fixture 100 according to the first embodiment in that the plurality of cameras is replaced with a plurality of human detection sensors, and further includes a microphone.

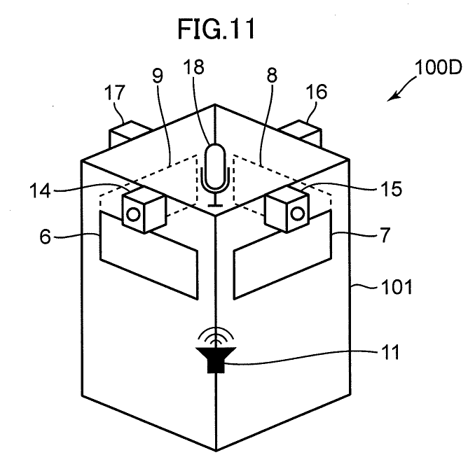

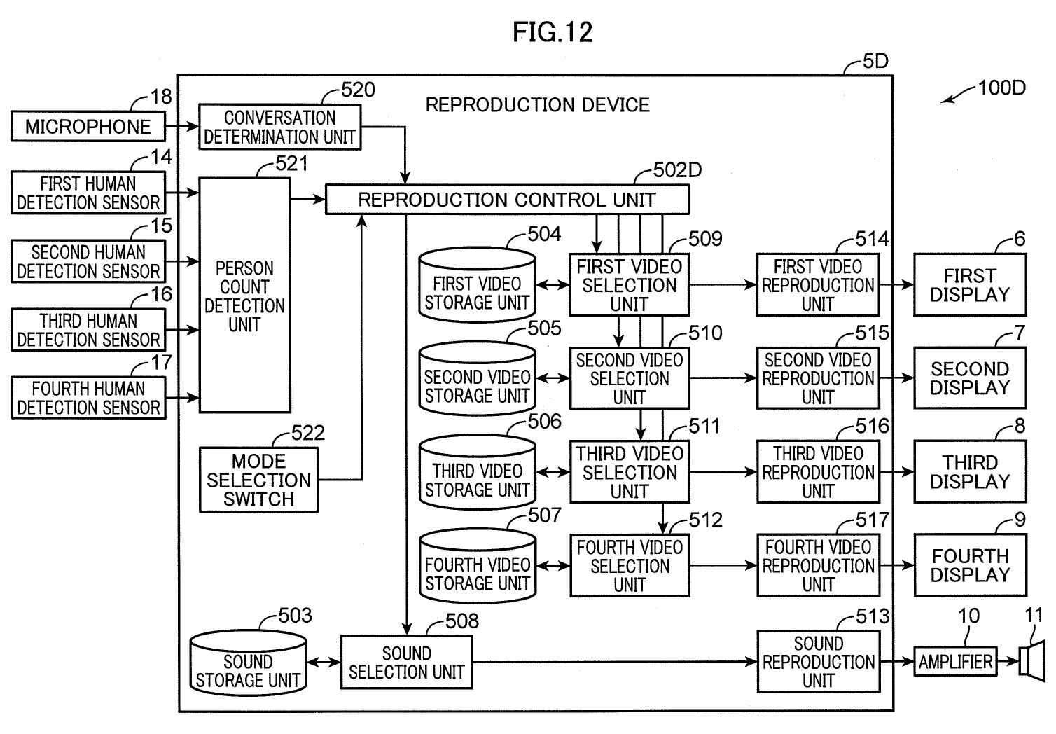

FIG. 11 is a diagram illustrating an external configuration of the reproduction fixture 100D according to the fourth embodiment, and FIG. 12 is a block diagram illustrating a configuration of the reproduction device 5D according to the fourth embodiment.

The reproduction fixture 100D includes a reproduction device 5D, a first display 6, a second display 7, a third display 8, a fourth display 9, an amplifier 10, a speaker 11, a first human detection sensor 14, a second human detection sensor 15, a third human detection sensor 16, a fourth human detection sensor 17, a microphone 18, and a housing 101.

Note that, in the fourth embodiment, the same configuration as that in the first embodiment will be denoted by the same reference sign as that in the first embodiment, and will be omitted from description.

The first human detection sensor 14, the second human detection sensor 15, the third human detection sensor 16, and the fourth human detection sensor 17 are provided on the four side surfaces of the housing 101, respectively. The first human detection sensor 14 is provided above the first display 6, and detects a person in a space in front of the first display 6. The second human detection sensor 15 is provided above the second display 7, and detects a person in a space in front of the second display 7. The third human detection sensor 16 is provided above the third display 8, and detects a person in a space in front of the third display 8. The fourth human detection sensor 17 is provided above the fourth display 9, and detects a person in a space in front of the fourth display 9. When detecting a person, the first human detection sensor 14, the second human detection sensor 15, the third human detection sensor 16, and the fourth human detection sensor 17 output detection information indicating that a person has been detected. The first human detection sensor 14, the second human detection sensor 15, the third human detection sensor 16, and the fourth human detection sensor 17 are examples of sensors.

The first human detection sensor 14, the second human detection sensor 15, the third human detection sensor 16, and the fourth human detection sensor 17 are connected to the reproduction device 5D itself or a hub (not illustrated) such as a communication device or a server in a wired or wireless manner so that detection information can be input to the reproduction device 5D. The first human detection sensor 14, the second human detection sensor 15, the third human detection sensor 16, and the fourth human detection sensor 17 may be communicably connected to the reproduction device 5D via a network. The first human detection sensor 14, the second human detection sensor 15, the third human detection sensor 16, and the fourth human detection sensor 17 output detection information to the reproduction device 5D. The detection information is an example of the sensing information.

The microphone 18 is disposed near the speaker 11. More specifically, the microphone 18 is disposed near an opening formed in an upper surface of the housing 101. The microphone 18 collects sounds around the speaker 11. The microphone 18 outputs sound information indicating the collected sound to the reproduction device 5D.

The reproduction device 5D includes a reproduction control unit 502D, a sound storage unit 503, a first video storage unit 504, a second video storage unit 505, a third video storage unit 506, a fourth video storage unit 507, a sound selection unit 508, a first video selection unit 509, a second video selection unit 510, a third video selection unit 511, a fourth video selection unit 512, a sound reproduction unit 513, a first video reproduction unit 514, a second video reproduction unit 515, a third video reproduction unit 516, a fourth video reproduction unit 517, a conversation determination unit 520, a person count detection unit 521, and a mode selection switch 522.

The conversation determination unit 520 acquires sound information (sensing information) from the microphone 18. The conversation determination unit 520 determines whether or not two or more persons present around the speaker 11 are having a conversation based on the sound information acquired by the microphone 18. The conversation determination unit 520 detects second information indicating whether or not two or more persons present around the speaker 11 are having a conversation.

The sensing information includes sound information in a first period acquired from the microphone 18. The conversation determination unit 520 detects silent sections in the first period of one or more persons and a sound pressure level of a conversation frequency range in the first period of one or more persons based on the sound information. When the total of silent sections is equal to or less than the second period and the sound pressure level of the conversation frequency range is equal to or greater than a threshold, the conversation determination unit 520 determines that two or more persons are having a conversation. On the other hand, when the total of silent sections is longer than the second period or when the sound pressure level of the conversation frequency range is lower than the threshold, the conversation determination unit 520 determines that two or more persons are not having a conversation. Note that details of the conversation determination processing by the conversation determination unit 520 will be described later.

The person count detection unit 521 acquires detection information (sensing information) from each of the first human detection sensor 14, the second human detection sensor 15, the third human detection sensor 16, and the fourth human detection sensor 17. The person count detection unit 521 detects the number of one or more persons present around the speaker 11 based on detection information from each of the first human detection sensor 14, the second human detection sensor 15, the third human detection sensor 16, and the fourth human detection sensor 17. The person count detection unit 521 detects first information indicating the number of one or more persons present around the speaker 11. The first human detection sensor 14, the second human detection sensor 15, the third human detection sensor 16, and the fourth human detection sensor 17 output detection information when detecting a person. Therefore, the number of pieces of detection information acquired from the first human detection sensor 14, the second human detection sensor 15, the third human detection sensor 16, and the fourth human detection sensor 17 is equal to the number of one or more persons around the speaker 11.

The person count detection unit 521 counts the number of pieces of detection information acquired from the first human detection sensor 14, the second human detection sensor 15, the third human detection sensor 16, and the fourth human detection sensor 17 to detect the number of one or more persons present around the speaker 11.

The mode selection switch 522 receives selection of either the relaxation mode or the concentration mode from a person around the speaker 11. In the fourth embodiment, unlike the first embodiment, it is not possible to determine whether or not one or more persons present around the speaker 11 are working. Therefore, in the fourth embodiment, the mode selection switch 522 receives in advance the selection of either the relaxation mode or the concentration mode.

When two or more persons are present around the speaker 11 and the two or more persons are having a conversation, the reproduction control unit 502D instructs the sound selection unit 508 to select the first sound signal.

When two or more persons are present around the speaker 11 and the two or more persons are having a conversation, the sound selection unit 508 selects the first sound signal.

Further, when one person is present around the speaker 11 and the relaxation mode is selected by the mode selection switch 522, the reproduction control unit 502D instructs the sound selection unit 508 to select the second sound signal. Further, when two or more persons are present around the speaker 11, the two or more persons are not having a conversation, and the relaxation mode is selected by the mode selection switch 522, the reproduction control unit 502D instructs the sound selection unit 508 to select the second sound signal.

Further, when one person is present around the speaker 11 and the concentration mode is selected by the mode selection switch 522, the reproduction control unit 502D instructs the sound selection unit 508 to select the third sound signal. Further, when two or more persons are present around the speaker 11, the two or more persons are not having a conversation, and the concentration mode is selected by the mode selection switch 522, the reproduction control unit 502D instructs the sound selection unit 508 to select the third sound signal.

Further, when two or more persons are present around the speaker 11 and the two or more persons are having a conversation, the reproduction control unit 502D instructs the first video selection unit 509, the second video selection unit 510, the third video selection unit 511, and the fourth video selection unit 512 to select the first video signal.

When two or more persons are present around the speaker 11 and the two or more persons are having a conversation, the first video selection unit 509, the second video selection unit 510, the third video selection unit 511, and the fourth video selection unit 512 select the first video signal.

Further, when one person is present around the speaker 11 and the relaxation mode is selected by the mode selection switch 522, the reproduction control unit 502D instructs the first video selection unit 509, the second video selection unit 510, the third video selection unit 511, and the fourth video selection unit 512 to select the second video signal. Further, when two or more persons are present around the speaker 11, two or more persons are not having a conversation, and the relaxation mode is selected by the mode selection switch 522, the reproduction control unit 502D instructs the first video selection unit 509, the second video selection unit 510, the third video selection unit 511, and the fourth video selection unit 512 to select the second video signal.

Further, when one person is present around the speaker 11 and the concentration mode is selected by the mode selection switch 522, the reproduction control unit 502D instructs the first video selection unit 509, the second video selection unit 510, the third video selection unit 511, and the fourth video selection unit 512 to select the third video signal. Further, when two or more persons are present around the speaker 11, two or more persons are not having a conversation, and the concentration mode is selected by mode selection switch 522, the reproduction control unit 502D instructs the first video selection unit 509, the second video selection unit 510, the third video selection unit 511, and the fourth video selection unit 512 to select the third video signal.

Note that in the fourth embodiment, the mode selection switch 522 receives selection of either the relaxation mode or the concentration mode from a person around the speaker 11, but the present disclosure is not particularly limited thereto. When one person is present around the speaker 11, or when two or more persons are present around the speaker 11 and two or more persons are not having a conversation, the reproduction control unit 502D may determine in advance which of the second sound signal and the third sound signal to select. In addition, when one person is present around the speaker 11, or when two or more persons are present around the speaker 11 and two or more persons are not having a conversation, the reproduction control unit 502D may determine in advance which of the second video signal and the third video signal to select.

Next, reproduction processing by the reproduction device 5D according to the fourth embodiment of the present disclosure will be described.

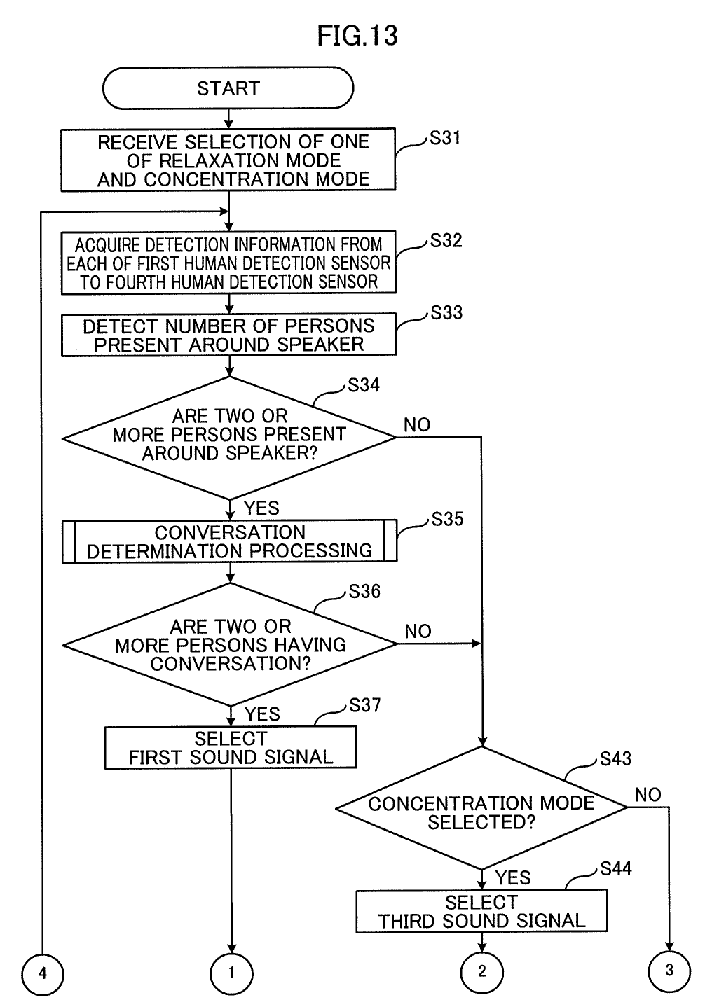

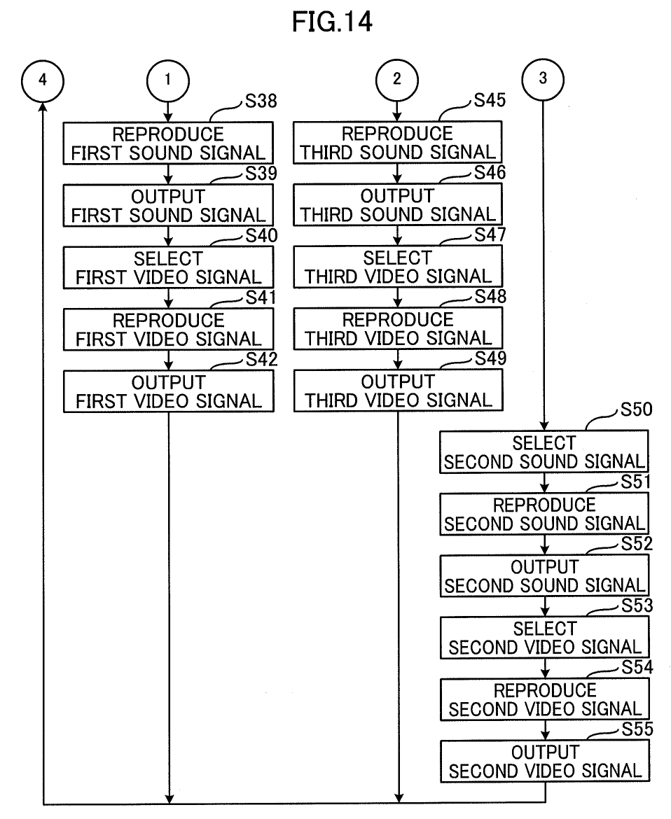

FIG. 13 is a first flowchart for describing reproduction processing by the reproduction device 5D according to the fourth embodiment of the present disclosure, and FIG. 14 is a second flowchart for describing the reproduction processing by the reproduction device 5D according to the fourth embodiment of the present disclosure.

First, in step S31, the mode selection switch 522 receives selection of either the relaxation mode or the concentration mode from a person around the speaker 11. A person who wants to relax selects the relaxation mode, and a person who wants to concentrate on work selects the concentration mode.

Next, in step S32, the person count detection unit 521 acquires detection information from each of the first human detection sensor 14 to the fourth human detection sensor 17. The detection information is information indicating that a person has been detected.

Next, in step S33, the person count detection unit 521 detects the number of persons present around the speaker 11 based on the detection information from each of the first human detection sensor 14 to the fourth human detection sensor 17.

Next, in step S34, the reproduction control unit 502D determines whether or not two or more persons are present around the speaker 11 based on the person count detected by the person count detection unit 521.

Here, when it is determined that less than two persons are present around the speaker 11, that is, when it is determined that no more than one person is present around the speaker 11 (NO in step S34), the processing proceeds to step S43.

On the other hand, when it is determined that two or more persons are present around the speaker 11 (YES in step S34), the reproduction control unit 502D performs conversation determination processing of determining whether or not two or more persons present around the speaker 11 are having a conversation in step S35.

Here, details of the conversation determination processing by the reproduction control unit 502D will be described.

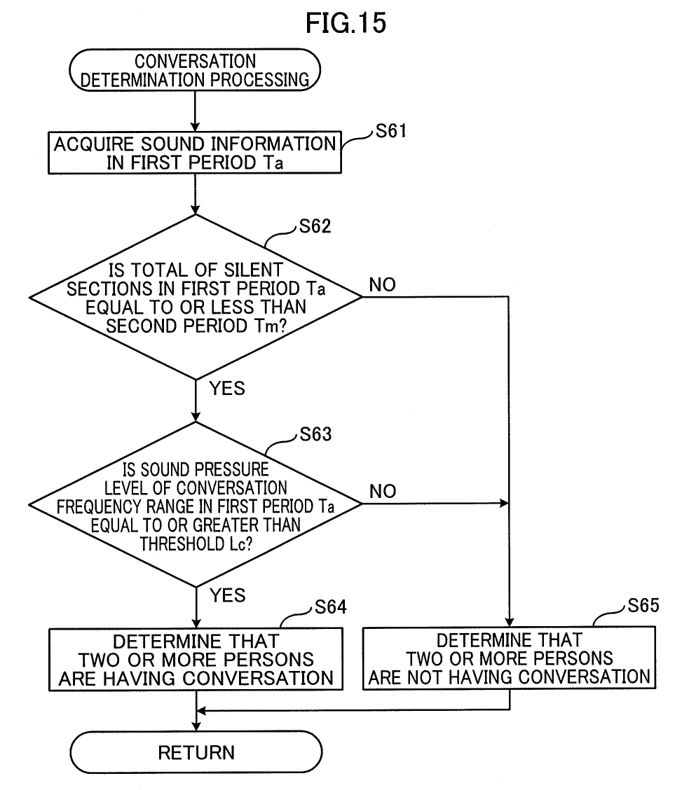

FIG. 15 is a flowchart for explaining conversation determination processing by the reproduction control unit 502D according to the fourth embodiment of the present disclosure.

First, in step S61, the reproduction control unit 502D acquires sound information in the first period Ta. The first period Ta is, for example, 10 seconds. Note that the memory (not illustrated) stores sound information acquired from the microphone. The reproduction control unit 502D acquires the stored sound information of the first period Ta from the memory.

Next, in step S62, the reproduction control unit 502D determines whether or not the total of the silent sections in the first period Ta is equal to or less than the second period Tm. The second period Tm is shorter than the first period Ta, and is, for example, 5 seconds.

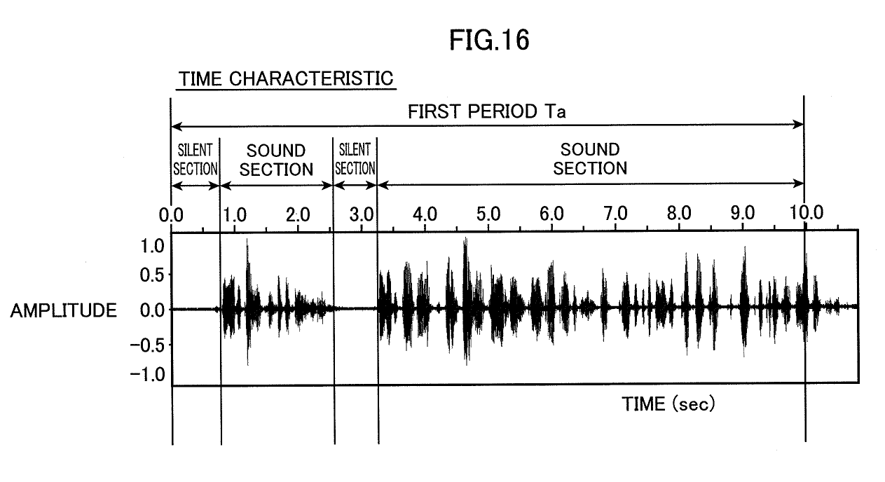

FIG. 16 is a diagram illustrating an example of a time characteristic of the sound information in the first period Ta. In FIG. 16, the vertical axis represents amplitude, and the horizontal axis represents time (second).

As illustrated in FIG. 16, the silent section represents a section in which no sound is present, and a sound section represents a section in which sound is present. If the silent section is long, it can be determined that two or more persons are not having a conversation.

The reproduction control unit 502D calculates the total of the silent sections in the first period Ta. Then, the reproduction control unit 502D determines whether or not the total of the silent sections in the first period Ta is equal to or less than the second period Tm.

Returning to FIG. 15, when it is determined that the total of the silent sections in the first period Ta is equal to or less than the second period Tm (YES in step S62), in step S63, the reproduction control unit 502D determines whether or not the sound pressure level of the conversation frequency range in the first period Ta is equal to or greater than a threshold Lc. The conversation frequency range is, for example, 125 Hz to 2000 Hz. The threshold Lc is, for example, -60 dB.

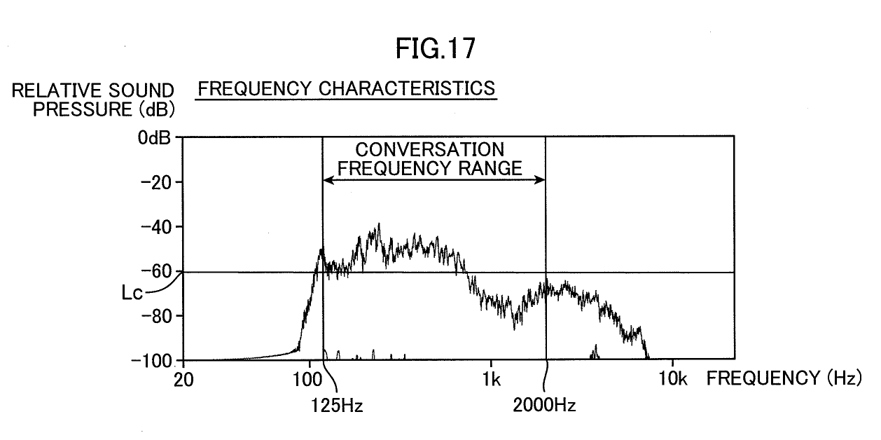

FIG. 17 is a diagram illustrating an example of frequency characteristics of the sound information in the first period Ta. In FIG. 17, the vertical axis represents the relative sound pressure level (dB), and the horizontal axis represents the frequency (Hz).

In FIG. 17, the sound pressure level of the conversation frequency range in the first period Ta is equal to or greater than the threshold Lc. In this case, the reproduction control unit 502D determines that the sound pressure level of the conversation frequency range within the first period Ta is equal to or greater than the threshold Lc.

Returning to FIG. 15, when it is determined that the sound pressure level in the conversation frequency range within the first period Ta is equal to or greater than the threshold Lc (YES in step S63), in step S64, the reproduction control unit 502D determines that two or more persons present around the speaker 11 are having a conversation.

On the other hand, when it is determined that the total of the silent sections in the first period Ta is not equal to or less than the second period Tm (NO in step S62), or when it is determined that the sound pressure level in the conversation frequency range in the first period Ta is not equal to or greater than the threshold Lc (NO in step S63), the reproduction control unit 502D determines in step S65 that two or more persons around the speaker 11 are not having a conversation.

Returning to FIG. 13, next, in step S36, the reproduction control unit 502D determines whether or not two or more persons present around the speaker 11 are having a conversation based on the result of the conversation determination processing.

Here, when it is determined that two or more persons present around the speaker 11 are not having a conversation (NO in step S36), the processing proceeds to step S43.

On the other hand, when it is determined that two or more persons present around the speaker 11 are having a conversation (YES in step S36), the sound selection unit 508 selects the first sound signal for encouraging conversation in step S37. Note that, when it is determined that two or more persons present around the speaker 11 are having a conversation, the reproduction control unit 502D instructs the sound selection unit 508 to select the first sound signal. The sound selection unit 508 reads the first sound signal from the sound storage unit 503 and outputs the first sound signal to the sound reproduction unit 513.

Note that processing of steps S38 to S42 is identical to the processing of steps S6 to S10 illustrated in FIG. 6, and thus description thereof will be omitted.

On the other hand, when it is determined in step S34 that less than two persons are present around the speaker 11, that is, when it is determined that no more than one person is present around the speaker 11 (NO in step S34), or when it is determined in step S36 that two or more persons present around the speaker 11 are not having a conversation (NO in step S36), the reproduction control unit 502D determines in step S43 whether or not the concentration mode has been selected by the mode selection switch 522.

Here, when it is determined that the concentration mode has been selected by the mode selection switch 522 (YES in step S43), the sound selection unit 508 selects the third sound signal for enhancing the concentration in step S44. Note that, when it is determined that the concentration mode has been selected by the mode selection switch 522, the reproduction control unit 502D instructs the sound selection unit 508 to select the third sound signal. The sound selection unit 508 reads the third sound signal from the sound storage unit 503 and outputs the third sound signal to the sound reproduction unit 513.

Note that processing in steps S45 to S49 is identical to the processing in steps S13 to S17 illustrated in FIG. 6, and thus description thereof will be omitted.

On the other hand, when it is determined that the concentration mode has not been selected by the mode selection switch 522, that is, when it is determined that the relaxation mode has been selected by the mode selection switch 522 (NO in step S43), the sound selection unit 508 selects the second sound signal having a relaxation effect in step S50. Note that, when it is determined that the relaxation mode has been selected by the mode selection switch 522, the reproduction control unit 502D instructs the sound selection unit 508 to select the second sound signal. The sound selection unit 508 reads the second sound signal from the sound storage unit 503 and outputs the second sound signal to the sound reproduction unit 513.

Note that processing of steps S51 to S55 is identical to the processing of steps S19 to S23 illustrated in FIG. 6, and thus description thereof will be omitted.

As described above, in the fourth embodiment, it is possible to determine whether or not two or more persons are having a conversation based on the sound information acquired from the microphone 18.

Note that, before step S34, the reproduction control unit 502D may determine whether or not one or more persons are present around the speaker 11. Then, when it is determined that one or more persons are present around the speaker 11, the processing may proceed to step S34. In addition, when it is determined that less than one person is present around the speaker 11, that is, when it is determined that no person is present around the speaker 11, the processing may return to step S31. Thus, when it is determined in step S34 that less than two persons are present around the speaker 11, one person is present around the speaker 11.

Also in the present fourth embodiment, as in the modification example of the first embodiment, reproduction fixture 100D may include a table 102. One or more tables may be disposed in front of the one or more displays, respectively. Tables 102 are disposed so as to surround the four side surfaces of the housing 101. The tables 102 include a first table 1021, a second table 1022, a third table 1023, and a fourth table 1024. The first table 1021 is disposed in front of the first display 6, the second table 1022 is disposed in front of the second display 7, the third table 1023 is disposed in front of the third display 8, and the fourth table 1024 is disposed in front of the fourth display 9.

### Fifth embodiment

In the first to fourth embodiments, the first display 6 to the fourth display 9 display the same video, but in a fifth embodiment, the first display 6 to the fourth display 9 can display different videos.

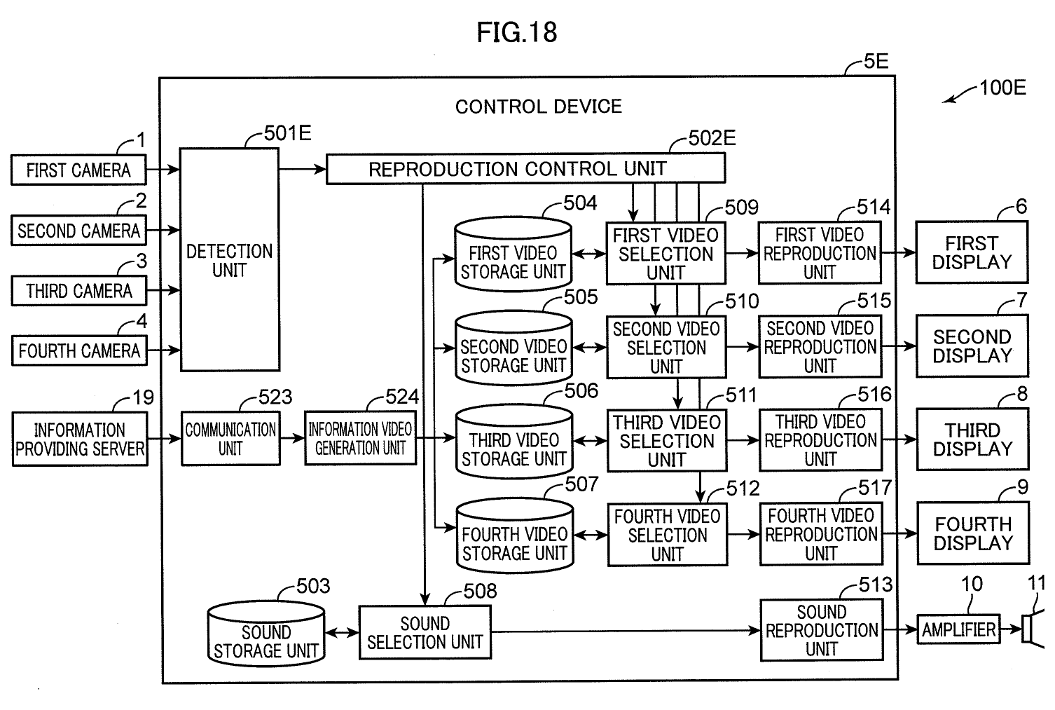

FIG. 18 is a block diagram illustrating a configuration of a reproduction device 5E according to the fifth embodiment.

The reproduction fixture 100E includes a first camera 1, a second camera 2, a third camera 3, a fourth camera 4, a reproduction device 5E, a first display 6, a second display 7, a third display 8, a fourth display 9, an amplifier 10, a speaker 11, and a housing 101 (not illustrated).

Note that, in the fifth embodiment, the same configuration as that in the first embodiment will be denoted by the same reference sign as that in the first embodiment, and will be omitted from description.

The information providing server 19 is a server that provides various types of information. The information providing server 19 provides, for example, weather forecast, news, advertisement, information regarding a building where the reproduction fixture 100E is disposed, information regarding a company where the reproduction fixture 100E is disposed, or the like. The information providing server 19 transmits various kinds of information to the reproduction device 5E.

The reproduction device 5E includes a detection unit 501E, a reproduction control unit 502E, a sound storage unit 503, a first video storage unit 504, a second video storage unit 505, a third video storage unit 506, a fourth video storage unit 507, a sound selection unit 508, a first video selection unit 509, a second video selection unit 510, a third video selection unit 511, a fourth video selection unit 512, a sound reproduction unit 513, a first video reproduction unit 514, a second video reproduction unit 515, a third video reproduction unit 516, a fourth video reproduction unit 517, a communication unit 523, and an information video generation unit 524.

The communication unit 523 receives various types of information from the information providing server 19. The communication unit 523 transmits request information for requesting various types of information to the information providing server 19. Upon receiving the request information, the information providing server 19 transmits various types of information to the reproduction device 5E. The communication unit 523 receives various types of information transmitted by the information providing server 19. Note that the information providing server 19 may periodically transmit various types of information to the reproduction device 5E. The communication unit 523 may receive various types of information periodically transmitted by the information providing server 19.

The information video generation unit 524 generates an information video signal indicating an information video based on the various types of information received by the communication unit 523. The information video includes, for example, a video indicating a weather forecast, a video indicating news, a video indicating an advertisement, a video indicating information on a building where the reproduction fixture 100E is disposed, or a video indicating information on a company where the reproduction fixture 100E is disposed. The information video generation unit 524 stores the generated information video signal in the first video storage unit 504, the second video storage unit 505, the third video storage unit 506, and the fourth video storage unit 507.

Note that the first video storage unit 504, the second video storage unit 505, the third video storage unit 506, and the fourth video storage unit 507 may store the information video signal in advance.

The surrounding information further includes fourth information indicating whether or not a person is present in front of each of the one or more displays. Based on the plurality of images captured by each of the first camera 1, the second camera 2, the third camera 3, and the fourth camera 4, the detection unit 501E specifies, from among the first display 6, the second display 7, the third display 8, and the fourth display 9, a display in front of which a person is present.

The reproduction control unit 502E determines whether or not a person is present in front of each of the one or more displays based on the fourth information included in the surrounding information. The reproduction control unit 502E determines whether or not a person is present in front of each of the first display 6, the second display 7, the third display 8, and the fourth display 9.

The first video reproduction unit 514, the second video reproduction unit 515, the third video reproduction unit 516, and the fourth video reproduction unit 517 reproduce one of the first video signal and the second video signal selected by each of the first video selection unit 509, the second video selection unit 510, the third video selection unit 511, and the fourth video selection unit 512, and output the one of the first video signal and the second video signal to the display in front of which it is determined by the reproduction control unit 502E that a person is present.

Further, the reproduction control unit 502E instructs the first video selection unit 509, the second video selection unit 510, the third video selection unit 511, and the fourth video selection unit 512 to output an information video signal to a display in front of which no person is present among the first display 6, the second display 7, the third display 8, and the fourth display 9.

When no person is present in front of the first display 6, the first video selection unit 509 selects the information video signal. The first video reproduction unit 514 reproduces the information video signal selected by the first video selection unit 509, and outputs the information video signal to the first display 6.

When no person is present in front of the second display 7, the second video selection unit 510 selects the information video signal. The second video reproduction unit 515 reproduces the information video signal selected by the second video selection unit 510, and outputs the information video signal to the second display 7.

When no person is present in front of the third display 8, the third video selection unit 511 selects the information video signal. The third video reproduction unit 516 reproduces the information video signal selected by the third video selection unit 511, and outputs the information video signal to the third display 8.

When no person is present in front of the fourth display 9, the fourth video selection unit 512 selects the information video signal. The fourth video reproduction unit 517 reproduces the information video signal selected by the fourth video selection unit 512, and outputs the information video signal to the fourth display 9.

Next, reproduction processing by the reproduction device 5E according to the fifth embodiment of the present disclosure will be described.

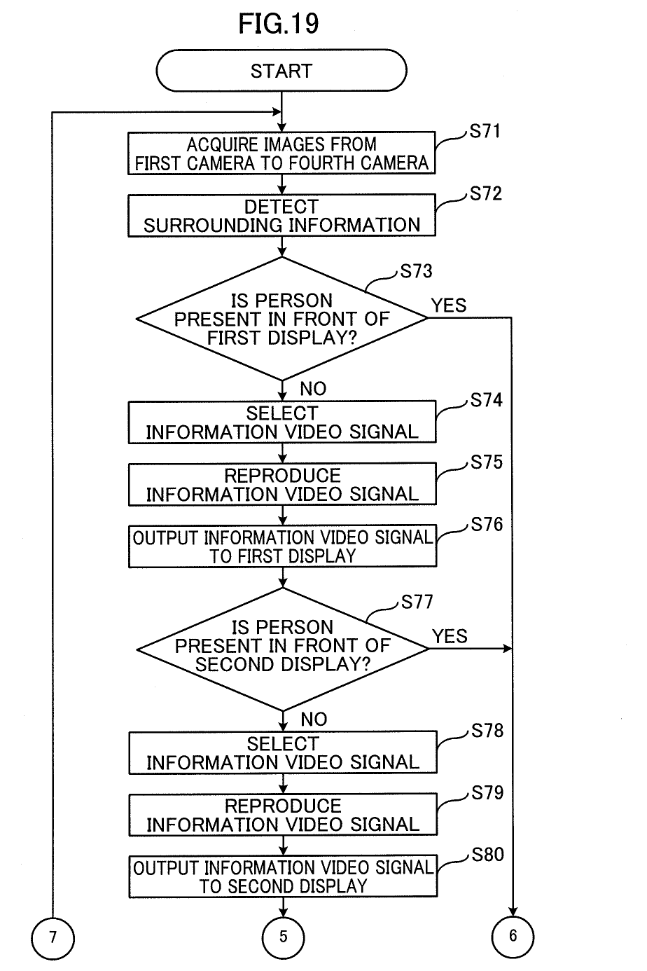

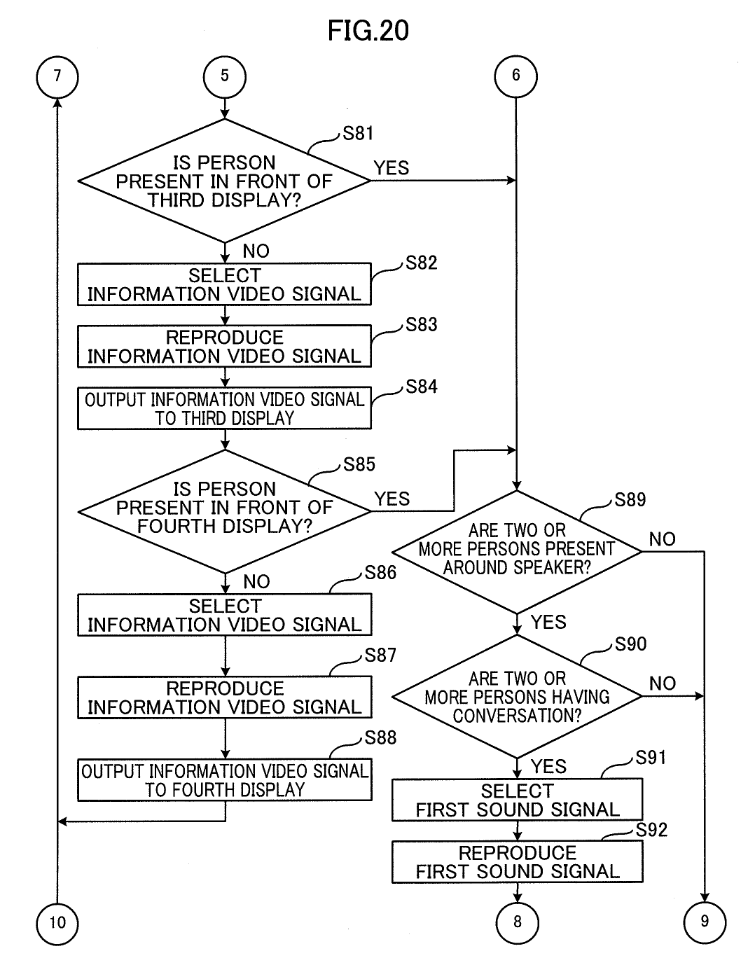

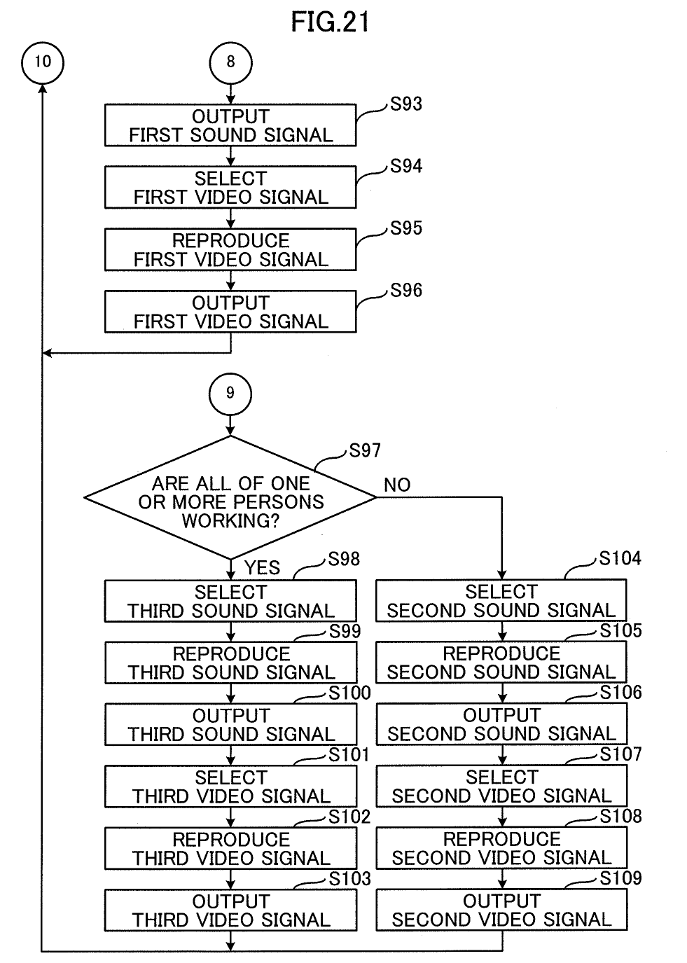

FIG. 19 is a first flowchart for describing reproduction processing by the reproduction device 5E according to the fifth embodiment of the present disclosure, FIG. 20 is a second flowchart for describing reproduction processing by the reproduction device 5E according to the fifth embodiment of the present disclosure, and FIG. 21 is a third flowchart for describing reproduction processing by the reproduction device 5E according to the fifth embodiment of the present disclosure.

First, in step S71, the detection unit 501E acquires images from each of the first camera 1 to the fourth camera 4.

Next, in step S72, the detection unit 501E detects the surrounding information indicating the surrounding state of the speaker 11 based on the plurality of acquired images. Here, the surrounding information includes first information indicating the number of one or more persons present around the speaker 11, second information indicating whether or not two or more persons present around the speaker 11 are having a conversation, third information indicating whether or not one or more persons present around the speaker 11 are working, and fourth information indicating whether or not a person is present in front of each of the one or more displays.

Next, in step S73, the reproduction control unit 502E determines whether or not a person is present in front of the first display 6 based on the fourth information included in the surrounding information.

Here, when it is determined that a person is present in front of the first display 6 (YES in step S73), the processing proceeds to step S89.

On the other hand, when it is determined that no person is present in front of the first display 6 (NO in step S73), the first video selection unit 509 selects the information video signal in step S74. Note that, when it is determined that no person is present in front of the first display 6, the reproduction control unit 502E instructs the first video selection unit 509 to select the information video signal. The first video selection unit 509 reads the information video signal from the first video storage unit 504, and outputs the information video signal to the first video reproduction unit 514.

Next, in step S75, the first video reproduction unit 514 reproduces the information video signal selected by the first video selection unit 509.

Next, in step S76, the first video reproduction unit 514 outputs the reproduced information video signal to the first display 6. The first display 6 displays the information video signal reproduced by the first video reproduction unit 514.

Next, in step S77, the reproduction control unit 502E determines whether or not a person is present in front of the second display 7 based on the fourth information included in the surrounding information.

Here, when it is determined that a person is present in front of the second display 7 (YES in step S77), the processing proceeds to step S89.

On the other hand, when it is determined that no person is present in front of the second display 7 (NO in step S77), the second video selection unit 510 selects the information video signal in step S78. Note that when it is determined that no person is present in front of the second display 7, the reproduction control unit 502E instructs the second video selection unit 510 to select the information video signal. The second video selection unit 510 reads the information video signal from the second video storage unit 505, and outputs the information video signal to the second video reproduction unit 515.

Next, in step S79, the second video reproduction unit 515 reproduces the information video signal selected by the second video selection unit 510.

Next, in step S80, the second video reproduction unit 515 outputs the reproduced information video signal to the second display 7. The second display 7 displays the information video signal reproduced by the second video reproduction unit 515.

Next, in step S81, the reproduction control unit 502E determines whether or not a person is present in front of the third display 8 based on the fourth information included in the surrounding information.

Here, when it is determined that a person is present in front of the third display 8 (YES in step S81), the processing proceeds to step S89.

On the other hand, when it is determined that no person is present in front of the third display 8 (NO in step S81), the third video selection unit 511 selects the information video signal in step S82. Note that when it is determined that no person is present in front of the third display 8, the reproduction control unit 502E instructs the third video selection unit 511 to select the information video signal. The third video selection unit 511 reads the information video signal from the third video storage unit 506, and outputs the information video signal to the third video reproduction unit 516.

Next, in step S83, the third video reproduction unit 516 reproduces the information video signal selected by the third video selection unit 511.

Next, in step S84, the third video reproduction unit 516 outputs the reproduced information video signal to the third display 8. The third display 8 displays the information video signal reproduced by the third video reproduction unit 516.

Next, in step S85, the reproduction control unit 502E determines whether or not a person is present in front of the fourth display 9 based on the fourth information included in the surrounding information.

Here, when it is determined that a person is present in front of the fourth display 9 (YES in step S85), the processing proceeds to step S89.

On the other hand, when it is determined that no person is present in front of the fourth display 9 (NO in step S85), the fourth video selection unit 512 selects the information video signal in step S86. Note that when it is determined that no person is present in front of the fourth display 9, the reproduction control unit 502E instructs the fourth video selection unit 512 to select the information video signal. The fourth video selection unit 512 reads the information video signal from the fourth video storage unit 507, and outputs the information video signal to the fourth video reproduction unit 517.

Next, in step S87, the fourth video reproduction unit 517 reproduces the information video signal selected by the fourth video selection unit 512.

Next, in step S88, the fourth video reproduction unit 517 outputs the reproduced information video signal to the fourth display 9. The fourth display 9 displays the information video signal reproduced by the fourth video reproduction unit 517.

Thus, since the information video signal is displayed on the display where there is no person around, a person who is not around the speaker 11 and is at a place away from the display can view the information video displayed on the display, whereby various types of information can be provided to the person at a place away from the display.

Next, in step S89, the reproduction control unit 502E determines whether or not two or more persons are present around the speaker 11 based on the first information included in the surrounding information.

Note that processing of steps S89 to S93 is identical to the processing of steps S3 to S7 illustrated in FIG. 6, and thus description thereof will be omitted.

Next, in step S94, the video selection unit corresponding to the display in front of which a person is present among the first video selection unit 509, the second video selection unit 510, the third video selection unit 511, and the fourth video selection unit 512 selects the first video signal for encouraging conversation. Note that, when it is determined that two or more persons present around the speaker 11 are having a conversation, the reproduction control unit 502E instructs the video selection unit corresponding to the display in front of which a person is present among the first video selection unit 509, the second video selection unit 510, the third video selection unit 511, and the fourth video selection unit 512 to select the first video signal.

When it is determined that there is a person in front of the first display 6, the first video selection unit 509 reads the first video signal from the first video storage unit 504, and outputs the first video signal to the first video reproduction unit 514. Further, when it is determined that there is a person in front of the second display 7, the second video selection unit 510 reads the first video signal from the second video storage unit 505, and outputs the first video signal to the second video reproduction unit 515. Further, when it is determined that there is a person in front of the third display 8, the third video selection unit 511 reads the first video signal from the third video storage unit 506, and outputs the first video signal to the third video reproduction unit 516. Further, when it is determined that there is a person in front of the fourth display 9, the fourth video selection unit 512 reads the first video signal from the fourth video storage unit 507, and outputs the first video signal to the fourth video reproduction unit 517.

Next, in step S95, the video reproduction unit corresponding to the display in front of which a person is present among the first video reproduction unit 514, the second video reproduction unit 515, the third video reproduction unit 516, and the fourth video reproduction unit 517 reproduces the selected first video signal.

When it is determined that there is a person in front of the first display 6, the first video reproduction unit 514 reproduces the first video signal selected by the first video selection unit 509. Further, when it is determined that there is a person in front of the second display 7, the second video reproduction unit 515 reproduces the first video signal selected by the second video selection unit 510. Further, when it is determined that there is a person in front of the third display 8, the third video reproduction unit 516 reproduces the first video signal selected by the third video selection unit 511. Further, when it is determined that there is a person in front of the fourth display 9, the fourth video reproduction unit 517 reproduces the first video signal selected by the fourth video selection unit 512.

Next, in step S96, the video reproduction unit corresponding to the display in front of which a person is present among the first video reproduction unit 514, the second video reproduction unit 515, the third video reproduction unit 516, and the fourth video reproduction unit 517 outputs the reproduced first video signal to the display in front of which a person is present among the first display 6, the second display 7, the third display 8, and the fourth display 9.

When it is determined that there is a person in front of the first display 6, the first display 6 displays the first video signal reproduced by the first video reproduction unit 514. When it is determined that there is a person in front of the second display 7, the second display 7 displays the first video signal reproduced by the second video reproduction unit 515. When it is determined that there is a person in front of the third display 8, the third display 8 displays the first video signal reproduced by the third video reproduction unit 516. When it is determined that there is a person in front of the fourth display 9, the fourth display 9 displays the first video signal reproduced by the fourth video reproduction unit 517.

On the other hand, when it is determined in step S89 that less than two persons are present around the speaker 11, that is, when it is determined that no more than one person is present around the speaker 11 (NO in step S89), or when it is determined in step S90 that two or more persons present around the speaker 11 are not having a conversation (NO in step S90), then in step S97, the reproduction control unit 502E determines whether or not all of the one or more persons present around the speaker 11 are working, based on the third information included in the surrounding information.

Note that processing of steps S97 to S100 is identical to the processing of steps S11 to S14 illustrated in FIG. 6, and thus description thereof will be omitted.

Next, in step S101, the video selection unit corresponding to the display in front of which a person is present among the first video selection unit 509, the second video selection unit 510, the third video selection unit 511, and the fourth video selection unit 512 selects the third video signal for enhancing the concentration. Note that, when it is determined that all of the one or more persons present around the speaker 11 are working, the reproduction control unit 502E instructs the video selection unit corresponding to the display in front of which a person is present among the first video selection unit 509, the second video selection unit 510, the third video selection unit 511, and the fourth video selection unit 512 to select the third video signal.

When it is determined that there is a person in front of the first display 6, the first video selection unit 509 reads the third video signal from the first video storage unit 504, and outputs the third video signal to the first video reproduction unit 514. Further, when it is determined that there is a person in front of the second display 7, the second video selection unit 510 reads the third video signal from the second video storage unit 505, and outputs the third video signal to the second video reproduction unit 515. Further, when it is determined that there is a person in front of the third display 8, the third video selection unit 511 reads the third video signal from the third video storage unit 506, and outputs the third video signal to the third video reproduction unit 516. Further, when it is determined that there is a person in front of the fourth display 9, the fourth video selection unit 512 reads the third video signal from the fourth video storage unit 507, and outputs the third video signal to the fourth video reproduction unit 517.

Next, in step S102, the video reproduction unit corresponding to the display in front of which a person is present among the first video reproduction unit 514, the second video reproduction unit 515, the third video reproduction unit 516, and the fourth video reproduction unit 517 reproduces the selected third video signal.

When it is determined that there is a person in front of the first display 6, the first video reproduction unit 514 reproduces the third video signal selected by the first video selection unit 509. Further, when it is determined that there is a person in front of the second display 7, the second video reproduction unit 515 reproduces the third video signal selected by the second video selection unit 510. Further, when it is determined that there is a person in front of the third display 8, the third video reproduction unit 516 reproduces the third video signal selected by the third video selection unit 511. Further, when it is determined that there is a person in front of the fourth display 9, the fourth video reproduction unit 517 reproduces the third video signal selected by the fourth video selection unit 512.

Next, in step S103, the video reproduction unit corresponding to the display in front of which a person is present among the first video reproduction unit 514, the second video reproduction unit 515, the third video reproduction unit 516, and the fourth video reproduction unit 517 outputs the reproduced third video signal to the display in front of which a person is present among the first display 6, the second display 7, the third display 8, and the fourth display 9.

When it is determined that there is a person in front of the first display 6, the first display 6 displays the third video signal reproduced by the first video reproduction unit 514. When it is determined that there is a person in front of the second display 7, the second display 7 displays the third video signal reproduced by the second video reproduction unit 515. When it is determined that there is a person in front of the third display 8, the third display 8 displays the third video signal reproduced by the third video reproduction unit 516. When it is determined that there is a person in front of the fourth display 9, the fourth display 9 displays the third video signal reproduced by the fourth video reproduction unit 517.

Note that processing of steps S104 to S106 is identical to the processing of steps S18 to S20 illustrated in FIG. 6, and thus description thereof will be omitted.

Next, in step S107, the video selection unit corresponding to the display in front of which a person is present among the first video selection unit 509, the second video selection unit 510, the third video selection unit 511, and the fourth video selection unit 512 selects the second video signal having the relaxation effect. Note that, when it is determined that all of the one or more persons present around the speaker 11 are not working, the reproduction control unit 502E instructs the video selection unit corresponding to the display in front of which a person is present among the first video selection unit 509, the second video selection unit 510, the third video selection unit 511, and the fourth video selection unit 512 to select the second video signal.

When it is determined that there is a person in front of the first display 6, the first video selection unit 509 reads the second video signal from the first video storage unit 504, and outputs the second video signal to the first video reproduction unit 514. Further, when it is determined that there is a person in front of the second display 7, the second video selection unit 510 reads the second video signal from the second video storage unit 505, and outputs the second video signal to the second video reproduction unit 515. Further, when it is determined that there is a person in front of the third display 8, the third video selection unit 511 reads the second video signal from the third video storage unit 506, and outputs the second video signal to the third video reproduction unit 516. Further, when it is determined that there is a person in front of the fourth display 9, the fourth video selection unit 512 reads the second video signal from the fourth video storage unit 507, and outputs the second video signal to the fourth video reproduction unit 517.

Next, in step S108, the video reproduction unit corresponding to the display in front of which a person is present among the first video reproduction unit 514, the second video reproduction unit 515, the third video reproduction unit 516, and the fourth video reproduction unit 517 reproduces the selected second video signal.

When it is determined that there is a person in front of the first display 6, the first video reproduction unit 514 reproduces the second video signal selected by the first video selection unit 509. Further, when it is determined that there is a person in front of the second display 7, the second video reproduction unit 515 reproduces the second video signal selected by the second video selection unit 510. Further, when it is determined that there is a person in front of the third display 8, the third video reproduction unit 516 reproduces the second video signal selected by the third video selection unit 511. Further, when it is determined that there is a person in front of the fourth display 9, the fourth video reproduction unit 517 reproduces the second video signal selected by the fourth video selection unit 512.

Next, in step S109, the video reproduction unit corresponding to the display in front of which a person is present among the first video reproduction unit 514, the second video reproduction unit 515, the third video reproduction unit 516, and the fourth video reproduction unit 517 outputs the reproduced second video signal to the display in front of which a person is present among the first display 6, the second display 7, the third display 8, and the fourth display 9.

When it is determined that there is a person in front of the first display 6, the first display 6 displays the second video signal reproduced by the first video reproduction unit 514. When it is determined that there is a person in front of the second display 7, the second display 7 displays the second video signal reproduced by the second video reproduction unit 515. When it is determined that there is a person in front of the third display 8, the third display 8 displays the second video signal reproduced by the third video reproduction unit 516. When it is determined that there is a person in front of the fourth display 9, the fourth display 9 displays the second video signal reproduced by the fourth video reproduction unit 517.

Thus, the first video signal, the second video signal, or the third video signal can be individually displayed on each of the one or more displays.

In the first to fifth embodiments, the housing 101 of the reproduction fixture 100 has a quadrangular prism shape, but the present disclosure is not particularly limited thereto, and may have another shape. The shape of the housing 101 may be, for example, a polygonal columnar shape or a cylindrical shape.

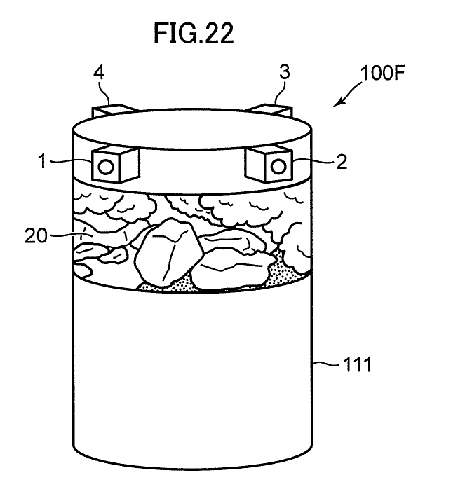

FIG. 22 is a view illustrating an external configuration of the reproduction fixture 100F according to Modification Example 1 of the first to fifth embodiments.

In Modification Example 1 of the first to fifth embodiments, the reproduction fixture 100F may include the cylindrical housing 111. An opening is formed on an upper surface of the housing 111. The inside of the housing 111 is hollow. For example, a house plant or the like may be provided inside the housing 111.

In addition, the reproduction fixture 100F may include one display 20 disposed along a side surface of the housing 111.

The first camera 1, the second camera 2, the third camera 3, and the fourth camera 4 are provided on the side surface of the housing 111 at equal intervals. The first camera 1, the second camera 2, the third camera 3, and the fourth camera 4 are provided above the display 20, and image each space obtained by dividing the space around the display 20 into four equal parts.

In this manner, the display 20 may be disposed on the side surface of the cylindrical housing 111. Thus, an environment suitable for conversation, break, or work can be provided to one or more persons present around the display 20.

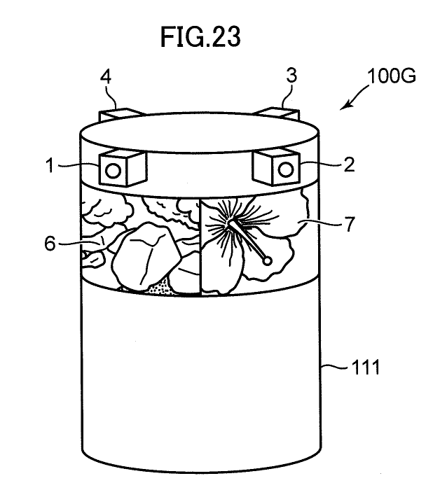

FIG. 23 is a view illustrating an external configuration of the reproduction fixture 100G according to Modification Example 2 of the first to fifth embodiments.

In Modification Example 2 of the first to fifth embodiments, the reproduction fixture 100G may include the cylindrical housing 111. An opening is formed on the upper surface of the housing 111. The inside of the housing 111 is hollow. For example, a house plant or the like may be provided inside the housing 111.

Further, while the reproduction fixture 100F of Modification Example 1 of the first to fifth embodiments includes one display 20, the reproduction fixture 100G of Modification Example 2 of the first to fifth embodiments includes four displays (first display 6, second display 7, the third display 8 (not illustrated), and fourth display 9 (not illustrated)). The first display 6, the second display 7, the third display 8 (not illustrated), and the fourth display 9 (not illustrated) are disposed at equal intervals along the side surface of the housing 111.

The first camera 1, the second camera 2, the third camera 3, and the fourth camera 4 are provided on the side surface of the housing 111 at equal intervals. The first camera 1 is provided above the first display 6 and images a space in front of the first display 6. The second camera 2 is provided above the second display 7 and images a space in front of the second display 7. The third camera 3 is provided above the third display 8 (not illustrated), and images a space in front of the third display 8. The fourth camera 4 is provided above the fourth display 9 (not illustrated), and images a space in front of the fourth display 9.

As described above, a plurality of displays (first display 6 to fourth display 9) may be disposed on the side surface of the cylindrical housing 111. Thus, it is possible to provide an environment suitable for conversation, break, or work to one or more persons present around the plurality of displays (first display 6 to fourth display 9).

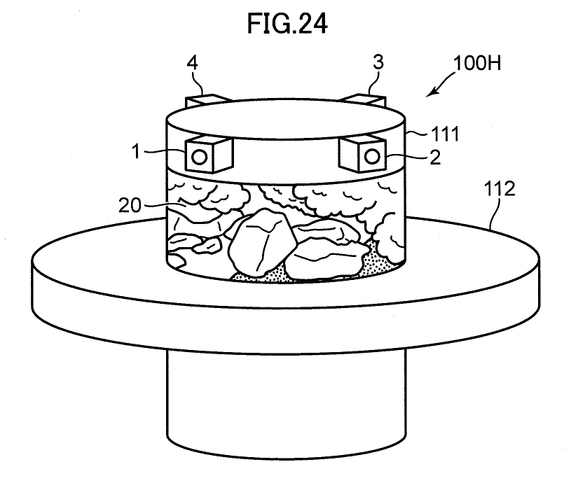

FIG. 24 is a view illustrating an external configuration of the reproduction fixture 100H according to Modification Example 3 of the first to fifth embodiments.

In Modification Example 3 of the first to fifth embodiments, similarly to Modification Example 1 of the first to fifth embodiments, the reproduction fixture 100H may include the cylindrical housing 111. In addition, the reproduction fixture 100F may include one display 20 disposed along a side surface of the housing 111. In addition, the reproduction fixture 100H may include a table 112.

The table 112 may be disposed in front of the display 20. The table 112 is disposed so as to surround a side surface of the housing 111. The height of the table 112 is set to a height that can be used in a state where a person stands or a height that can be used in a state where a person sits on a chair.

As described above, the display 20 may be disposed on the side surface of the cylindrical housing 111, and the table 112 may be disposed in front of the display 20. Thus, it is possible to provide an environment suitable for conversation, break, or work to one or more persons who use the table 112.

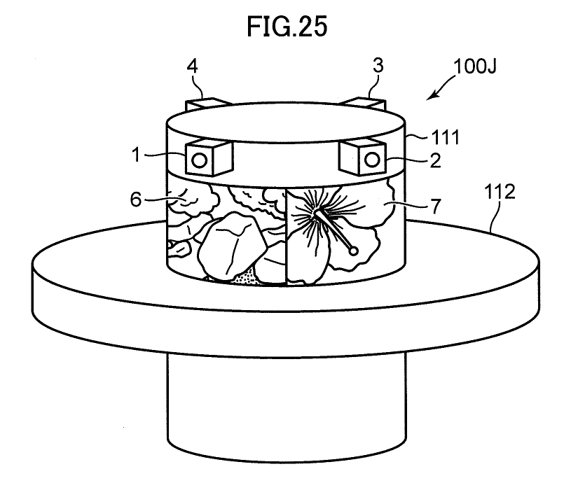

FIG. 25 is a view illustrating an external configuration of the reproduction fixture 100J according to Modification Example 4 of the first to fifth embodiments.

In Modification Example 4 of the first to fifth embodiments, the reproduction fixture 100J may include the cylindrical housing 111 as in Modification Example 2 of the first to fifth embodiments. Further, the first display 6, the second display 7, the third display 8 (not illustrated), and the fourth display 9 (not illustrated) are disposed at equal intervals along the side surface of the housing 111.

In addition, the reproduction fixture 100J may include the table 112. The table 112 may be disposed in front of the first display 6, the second display 7, the third display 8 (not illustrated), and the fourth display 9 (not illustrated). The table 112 is disposed so as to surround the side surface of the housing 111. The height of the table 112 is set to a height that can be used in a state where a person stands or a height that can be used in a state where a person sits on a chair.

As described above, the plurality of displays (first display 6 to fourth display 9) may be disposed on the side surface of the cylindrical housing 111, and the table 112 may be disposed in front of the plurality of displays (first display 6 to fourth display 9). Thus, it is possible to provide an environment suitable for conversation, break, or work to one or more persons who use the table 112.

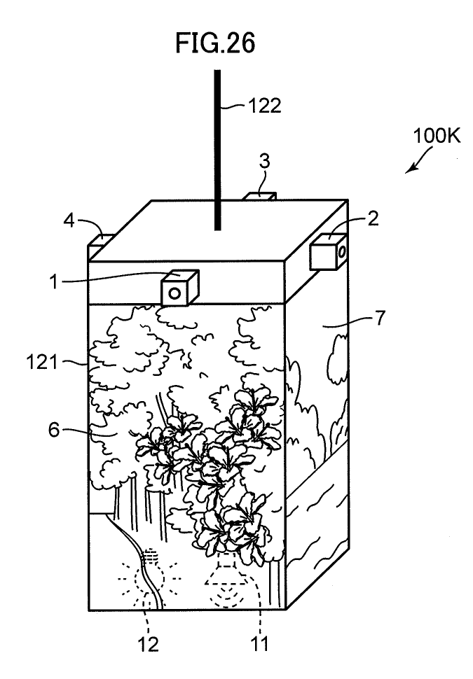

FIG. 26 is a view illustrating an external configuration of the reproduction fixture 100K according to Modification Example 5 of the first to fifth embodiments.

In Modification Example 5 of the first to fifth embodiments, the reproduction fixture 100K may be a suspended lighting device including one or more displays capable of reproducing video, a speaker capable of reproducing sound, and a lighting device capable of emitting light. The reproduction fixture 100K includes the housing 121 having a quadrangular prism shape, and a cable 122 for connecting an upper surface of the housing 121 and a ceiling. The reproduction fixture 100K is installed so as to be suspended from the ceiling at a predetermined height above the table or at any place in the space.

The reproduction fixture 100K of Modification Example 5 of the first to fifth embodiments includes four displays (first display 6, second display 7, the third display 8 (not illustrated), and fourth display 9 (not illustrated)). The first display 6, the second display 7, the third display 8 (not illustrated), and the fourth display 9 (not illustrated) are provided on four side surfaces of the housing 121, respectively.

The first camera 1, the second camera 2, the third camera 3, and the fourth camera 4 are provided on the four side surfaces of the housing 121, respectively.

The speaker 11 and the lighting device 12 are embedded in the housing 121. The lighting device 12 illuminates the lower side of the housing 121. In addition, the sensor such as a camera may be installed so as to be embedded inside the housing 121 similarly to the speaker 11, or may be installed externally at any place such as a top surface, a bottom surface, or a side surface of the housing 121. In addition, the sensor such as a camera need not necessarily be installed directly on the housing 121, and may be installed, for example, on the ceiling above the housing 121. In addition, the sensor may be installed at any position on the ceiling or the wall surface. In addition, the shape of the housing 121 may be, for example, a polygonal columnar shape or a cylindrical shape.

The control of the first display 6, the second display 7, the third display 8 (not illustrated), the fourth display 9 (not illustrated), the speaker 11, the lighting device 12, and the like is the same as that of the other embodiments and other modification examples.

As described above, the reproduction fixture 100K may be a suspended lighting device. Thus, it is possible to provide an environment suitable for conversation, break, or work to one or more persons present around the lighting device.

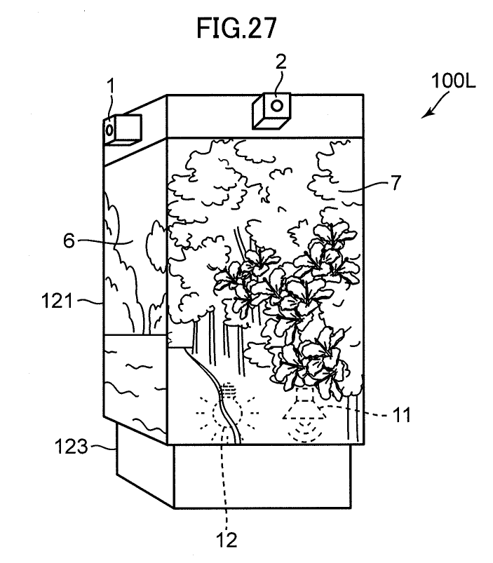

FIG. 27 is a view illustrating an external configuration of the reproduction fixture 100L according to Modification Example 6 of the first to fifth embodiments.

In Modification Example 6 of the first to fifth embodiments, the reproduction fixture 100L may be a stationary lighting device including one or more displays capable of reproducing video, a speaker capable of reproducing sound, and a lighting device capable of emitting light. The reproduction fixture 100L includes the housing 121 having a quadrangular prism shape and a base 123 on which the housing 121 is mounted. The reproduction fixture 100L is installed on a structure such as a table or a counter.

The reproduction fixture 100L according to Modification Example 6 of the first to fifth embodiments includes four displays (first display 6, second display 7, the third display 8 (not illustrated), and fourth display 9 (not illustrated)). The first display 6, the second display 7, the third display 8 (not illustrated), and the fourth display 9 (not illustrated) are provided on the four side surfaces of the housing 121, respectively.

The first camera 1, the second camera 2, the third camera 3 (not illustrated), and the fourth camera 4 (not illustrated) are provided on the four side surfaces of the housing 121, respectively.

The speaker 11 and the lighting device 12 are embedded in the housing 121. The lighting device 12 illuminates the lower side of the housing 121. In addition, the sensor such as a camera may be installed so as to be embedded inside the housing 121 similarly to the speaker 11, or may be installed externally at any place such as a top surface, a bottom surface, or a side surface of the housing 121. In addition, the sensor such as a camera need not necessarily be installed directly on the housing 121, and may be installed, for example, at any position of a table or a counter on which the reproduction fixture 100L is placed. In addition, the sensor may be installed at any position on the ceiling or the wall surface. In addition, the shape of the housing 121 may be, for example, a polygonal columnar shape or a cylindrical shape.

The control of the first display 6, the second display 7, the third display 8 (not illustrated), the fourth display 9 (not illustrated), the speaker 11, the lighting device 12, and the like is the same as that of the other embodiments and other modification examples.

As described above, the reproduction fixture 100L may be a stationary lighting device. Thus, it is possible to provide an environment suitable for conversation, break, or work to one or more persons present around the lighting device.

In the first to fifth embodiments, an opening is formed in the upper surface of the housing 101 of the reproduction fixture 100, but the present disclosure is not particularly limited thereto, and other shapes may be used. In addition, the upper surface of the housing 101 may be, for example, a top surface that does not include an opening, or may be a top surface that includes a plurality of openings.

In addition, in the first to fifth embodiments, the amplifier 10 and the speaker 11 may be installed so as to be incorporated in the top surface, or may be installed on the top surface.

In addition, in the second embodiment, the lighting device 12 may be installed so as to be incorporated in the top surface, or may be installed on the top surface.

In addition, in the fourth embodiment, the microphone 18 may be installed so as to be incorporated in the top surface, or may be installed on the top surface.

Note that in each of the above embodiments, each component may be implemented by being configured with dedicated hardware or by execution of a software program suitable for each component. Each component may be implemented by a program execution unit, such as a CPU or a processor, reading and executing a software program recorded on a recording medium such as a hard disk or a semiconductor memory. In addition, a program may be executed by another independent computer system by recording and transferring the program on a recording medium or transferring the program via a network.

Some or all functions of the devices according to the embodiments of the present disclosure are implemented as Large Scale Integration (LSI) which is typically an integrated circuit. These may be individually integrated into one chip, or may be integrated into one chip so as to include some or all of these. In addition, circuit integration is not limited to LSI, and may be implemented by a dedicated circuit or a general-purpose processor. A Field Programmable Gate Array (FPGA) that can be programmed after manufacturing of LSI or a reconfigurable processor in which connection and setting of circuit cells inside the LSI can be reconfigured may be used.

In addition, some or all functions of the device according to the embodiment of the present disclosure may be implemented by a processor such as a CPU executing a program.

Further, the numerical figures used above are all illustrated to specifically describe the present disclosure, and the present disclosure is not limited to the illustrated numerical figures.

In addition, order in which steps illustrated in the above flowchart are executed is exemplified for specifically describing the present disclosure, and may be any order other than the above order as long as a similar effect is obtained. In addition, some of the above steps may be executed simultaneously (in parallel) with other steps.

The technology according to the present disclosure can provide an environment suitable for an action of one or more persons, and thus is useful as a technology for reproducing sound.

1. A reproduction device comprising:
an acquisition unit that acquires sensing information from a sensor;
a detection unit that detects surrounding information indicating a surrounding state of a speaker based on the sensing information;
a sound selection unit that selects one of a first sound signal including a conversation frequency range and a second sound signal not including the conversation frequency range based on the surrounding information; and
a sound reproduction unit that reproduces one of the first sound signal and the second sound signal selected, and outputs the first sound signal or the second sound signal to the speaker,
wherein the surrounding information includes first information indicating a number of one or more persons present around the speaker.

2. The reproduction device according to claim 1, wherein
the surrounding information further includes second information indicating whether or not two or more persons present around the speaker are having a conversation.

3. The reproduction device according to claim 2, further comprising:
a video selection unit that selects one of a first video signal to be reproduced together with the first sound signal and a second video signal to be reproduced together with the second sound signal based on the surrounding information; and
a video reproduction unit that reproduces either the first video signal or the second video signal selected and outputs the first video signal or the second video signal to one or more displays.

4. The reproduction device according to claim 3, wherein
the sound selection unit selects the first sound signal when two or more persons are present around the speaker and the two or more persons are having a conversation, and
the video selection unit selects the first video signal when two or more persons are present around the speaker and the two or more persons are having a conversation.

5. The reproduction device according to claim 3, wherein
the sound selection unit selects the second sound signal when one person is present around the speaker or when two or more persons are present around the speaker and the two or more persons are not having a conversation, and
the video selection unit selects the second video signal when one person is present around the speaker or when two or more persons are present around the speaker and the two or more persons are not having a conversation.

6. The reproduction device according to claim 2, wherein
the surrounding information further includes third information indicating whether or not one or more persons present around the speaker are working,
the sound selection unit selects the second sound signal when one person is present around the speaker and the one person is not working or when two or more persons are present around the speaker and the two or more persons are not working,
the sound selection unit selects a third sound signal when one person is present around the speaker and the one person is working, or when two or more persons are present around the speaker and the two or more persons are working,
the sound reproduction unit reproduces any one of the first sound signal, the second sound signal, and the third sound signal selected, and outputs the sound signal to the speaker,
the first sound signal is a nonstationary sound including the conversation frequency range,
the second sound signal is a nonstationary sound not including the conversation frequency range, and
the third sound signal is a stationary sound including the conversation frequency range.

7. The reproduction device according to claim 6, further comprising:
a video selection unit that selects one of a first video signal to be reproduced together with the first sound signal, a second video signal to be reproduced together with the second sound signal, and a third video signal to be reproduced together with the third sound signal based on the surrounding information; and
a video reproduction unit that reproduces one of the first video signal, the second video signal, and the third video signal that is selected, and outputs the one of the first video signal, the second video signal, and the third video signal to one or more displays.

8. The reproduction device according to claim 3, wherein
the sound reproduction unit changes a volume of either the first sound signal or the second sound signal selected, and
the video selection unit changes luminance of either the first video signal or the second video signal that is selected.

9. The reproduction device according to claim 3, wherein
the sensing information includes sound information in a first period acquired from a microphone,
the detection unit detects silent sections in the first period of the one or more persons and a sound pressure level of a conversation frequency range in the first period of the one or more persons based on the sound information, and determines that the two or more persons are having a conversation when a total of the silent sections is equal to or less than a second period and the sound pressure level of the conversation frequency range is equal to or greater than a threshold,
the sound selection unit selects the first sound signal when two or more persons are present around the speaker and the two or more persons are having a conversation, and
the video selection unit selects the first video signal when two or more persons are present around the speaker and the two or more persons are having a conversation.

10. The reproduction device according to claim 3, wherein
the acquisition unit further acquires time information indicating a current time,
the sound selection unit selects the second sound signal corresponding to the current time based on the surrounding information and the time information, and
the video selection unit selects the second video signal corresponding to the current time based on the surrounding information and the time information.

11. The reproduction device according to claim 3, wherein
the acquisition unit further acquires weather information regarding a current weather,
the sound selection unit selects the second sound signal corresponding to the current weather based on the surrounding information and the weather information, and
the video selection unit selects the second video signal corresponding to the current weather based on the surrounding information and the weather information.

12. The reproduction device according to claim 3, wherein
the surrounding information further includes fourth information indicating whether or not a person is present in front of each of the one or more displays,
the reproduction device further comprises a determination unit that determines whether or not the person is present in front of each of the one or more displays based on the fourth information, and
the video reproduction unit reproduces one of the first video signal and the second video signal selected, and outputs the one of the first video signal and the second video signal to the display in front of which it is determined that the person is present.

13. The reproduction device according to claim 3, wherein
one or more tables are disposed in front of the one or more displays, respectively, and
the first information indicates, for each of the one or more tables, a number of one or more persons who use the table, and
the second information indicates, for each of the one or more tables, whether or not two or more persons using the table are having a conversation.

14. The reproduction device according to claim 1, wherein
the sensor includes at least one of a camera, a microphone, or a human detection sensor.

15. The reproduction device according to claim 1, further comprising:
a lighting control unit that determines at least one of a color temperature or illuminance of a lighting device disposed near the speaker based on the surrounding information, and outputs a control signal for controlling the lighting device to the lighting device based on the determined at least one of the color temperature or the illuminance.

16. A reproduction method executed by a computer, the reproduction method comprising:
acquiring sensing information from a sensor;
detecting surrounding information indicating a surrounding state of a speaker based on the sensing information;
selecting one of a first sound signal including a conversation frequency range and a second sound signal not including the conversation frequency range based on the surrounding information; and
reproducing one of the first sound signal and the second sound signal selected, and outputting the first sound signal or the second sound signal to the speaker,
wherein the surrounding information includes first information indicating a number of one or more persons present around the speaker.

17. A non-transitory computer readable recording medium storing a reproduction program causing a computer to function as:
an acquisition unit that acquires sensing information from a sensor;
a detection unit that detects surrounding information indicating a surrounding state of a speaker based on the sensing information;
a sound selection unit that selects one of a first sound signal including a conversation frequency range and a second sound signal not including the conversation frequency range based on the surrounding information; and
a sound reproduction unit that reproduces one of the first sound signal and the second sound signal selected, and outputs the first sound signal or the second sound signal to the speaker,
wherein the surrounding information includes first information indicating a number of one or more persons present around the speaker.
